(19) United States
(12) Patent Application Publication
(10) Pub. No.: US 2007/0189584 A1
(43) Pub. Date: Aug. 16, 2007

(54) Specific expression face detection method, and imaging control method, apparatus and program

(75) Inventor: Yuanzhong Li, Tokyo (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/703,676

(22) Filed: Feb. 8, 2007

(30) Foreign Application Priority Data
Feb. 10, 2006 (JP) 033555/2006

(51) Int. Cl. G06K 9/00

(52) U.S. Cl. 382/118

(57) ABSTRACT

When detecting an image that includes a face with a specific expression, a face image of a predetermined person with a specific expression is registered in advance, and characteristic points that indicate the contours of face components forming the face in the registered image are extracted. Then, a face image is detected from a detection target image, and characteristic points that indicate the contours of face components forming the face in the detected face image are extracted. Then the characteristic points extracted from the detected face image are compared with the characteristic points extracted from the registered face image to obtain an index value that indicates the correlation in the positions of the characteristic points, and a determination is made whether the detected face image includes a face with an expression similar to the specific expression based on the magnitude of the index value.

### BACKGROUND OF THE INVENTION

1. Field of the Invention

The present invention relates to a specific expression face detection method and apparatus for detecting an image that includes a face with a specific expression, and a program for causing a computer to function as the specific expression face detection apparatus. The present invention also relates to an imaging control method and apparatus that employs the specific expression face detection method, and a program for causing a computer to function as the imaging control apparatus.

2. Description of the Related Art

When taking a snapshot, a person, the subject of the snapshot, is, in general, desirable to have a smiling face. On the other hand, when taking an identification photograph, a person, the subject of the photograph, is desirable to have a serious face. Consequently, various methods for detecting an image that includes a face with a specific expression, such as a smiling face, a serious face, or the like, or various methods for detecting characteristic points of a face required for the aforementioned face detection methods are proposed. Further, various imaging apparatuses which are controlled so that an image that includes a face with a specific expression is obtained are also proposed.

For example, U.S. patent application Publication No. 20050046730 proposes an imaging apparatus having functions to detect and cut out a face region from a moving picture under imaging through face detection, and to enlarge the face region for display on the display screen of the camera. This allows the user to depress the shutter button of the imaging apparatus while looking at the enlarged face of the subject, which facilitates confirmation of the facial expression, so that an image that includes a face with a desired expression may be obtained easily.

Further, Japanese Unexamined Patent Publication No. 2005-293539 proposes a method in which the contours of the upper and bottom ends of each component forming the face included in an image are extracted, the expression of the face is determined based on the distance between the contours, and bending degree of each contour.

Still further, Japanese Unexamined Patent Publication No. 2005-056388 proposes a method in which characteristic points of each group of predetermined regions of a face included in an inputted image is obtained, and characteristic points of each group of predetermined regions of a face with a predetermined expression included in an image is obtained. Then, based on the difference between the characteristic points, the score of each group of the predetermined regions is calculated, and the expression of the face included in the inputted image is determined based on the distribution of the scores.

Further, U.S. patent application Publication No. 20050102246 proposes a method in which an expression recognition system is learned using expression learning data sets constituted by a plurality of face images with a specific expression, which is the recognition target expression, and a plurality of face images with expressions different from the specific expression, and the expression of a face included in an image is recognized using the expression recognition system.

Still further, Japanese Unexamined Patent Publication No. 2005-108197 proposes a method in which characteristic amounts of a discrimination target image are calculated, and a determination is made whether a face is included in the image by referring to a first reference data learned from the characteristic amounts of multitudes of face images normalized in the positions of the eyes with a predetermined tolerance and of images of not of faces. If a face is included in the image, the positions of the eyes are identified by referring to a second reference data learned from the characteristic amounts of multitudes of face images normalized in the positions of the eyes with a tolerance which is smaller than the predetermined tolerance described above and of images of not of faces. This allows the face and eyes to be detected with high accuracy and robustness.

The imaging apparatus described in U.S. patent application Publication No. 20050046730, however, only recognizes the face of a subject and enlarges it for display, and does not automatically recognize the facial expression.

The characteristic points and amounts of faces required for recognizing the facial expressions differ from person to person. Thus, it is difficult to prescribe the facial expressions, such as a smiling face, or a serious face by generalizing them with the characteristic points and amounts. Further, the preference of the facial expressions also depends on the user. Thus, the expression recognition methods described in Japanese Unexamined Patent Publication Nos. 2005-293539 and 2005-056388, and U.S. patent application Publication No. 20050102246 may not always obtain desired recognition results for any person.

Further, Japanese Unexamined Patent Publication No. 2005-108197 proposes a method that detects just a face included in an image and the position of the eyes forming the face with high accuracy and robustness, and facial expressions are unable to be recognized by the method.

### SUMMARY OF THE INVENTION

In view of the circumstance described above, it is an object of the present invention to provide a specific expression face detection method capable of detecting an image that includes a face with a specific expression desired by the user, an imaging control method capable of readily imaging a face desired by the user using the specific expression face detection method, and apparatuses for implementing these methods and programs therefor.

A specific expression face detection method of the present invention includes the steps of:

accepting registration of an image that includes the face of a predetermined person with a specific face expression;

extracting characteristic points that indicate the contours of face components forming the face in the registered face image;

accepting input of a detection target image;

detecting a face image that includes a face from the detection target image;

extracting characteristic points that indicate the contours of face components forming the face in the detected face image;

calculating an index value that indicates the correlation in the positions of the characteristic points by comparing the characteristic points extracted from the face in the detected face image with the characteristic points extracted from the face in the registered image; and

determining whether the detected face image includes a face with an expression similar to the specific expression based on the magnitude of the index value.

In the specific expression face detection method of the present invention described above, the method may further include the step of selecting a face image that includes the face of the same person as the predetermined person from all of the detected face images by performing face recognition thereon, and wherein: the step of calculating an index value may be the step of calculating the index value by comparing the characteristic points extracted from the face in the selected face image with the characteristic points extracted from the face in the registered image; and the determining step may be the step of determining whether the selected face image includes a face with an expression similar to the specific expression.

Further, in the specific expression face detection method of the present invention described above, the step of accepting input of a detection target image may be the step of accepting input of a plurality of different images, and wherein: the step of detecting a face image, the step of extracting characteristic points from the detected face image, the step of calculating an index value, and the determining step may be the steps performed on each of the plurality of different images; and the method may further include the step of selecting an image that includes the face image determined to include a face with an expression similar to the specific expression and outputting information that identifies the selected image.

Still further, in the specific expression face detection method of the present invention described above, the detection target image may be an image obtained by an imaging means through imaging, and the method may further include the step of outputting at least one of a sign, a voice, a sound, and light according to the determination result to notify the determination result.

An imaging control method of the present invention includes the steps of:

accepting registration of an image that includes the face of a predetermined person with a specific face expression;

extracting characteristic points that indicate the contours of face components forming the face in the registered face image;

accepting input of a preliminarily recorded image obtained by an imaging means through preliminary imaging;

detecting a face image that includes a face from the preliminarily recorded image;

extracting characteristic points that indicate the contours of face components forming the face in the detected face image;

calculating an index value that indicates the correlation in the positions of the characteristic points by comparing the characteristic points extracted from the face in the detected face image with the characteristic points extracted from the face in the registered image;

determining whether the detected face image includes a face with an expression similar to the specific expression based on the magnitude of the index value; and

controlling the imaging means to allow final imaging according to the determination result.

In the imaging control method of the present invention described above, the method may further include the step of selecting a face image that includes the face of the same person as the predetermined person from all of the detected face images by performing face recognition thereon, and wherein: the step of calculating an index value may be the step of calculating the index value by comparing the characteristic points extracted from the face in the selected face image with the characteristic points extracted from the face in the registered image; and the determining step may be the step of determining whether the selected face image includes a face with an expression similar to the specific expression.

Further, in the imaging control method of the present invention described above, the step of controlling the imaging means to allow final imaging may perform the control of allowing final imaging according to the determination result that the detected face image includes a face with an expression similar to the specific expression.

Still further, in the imaging control method of the present invention described above, the step of controlling the imaging means to allow final imaging may perform the control of allowing final imaging according to the determination result that the detected face image does not include a face with an expression similar to the specific expression.

A specific expression face detection apparatus of the present invention includes:

an image registration means for accepting registration of an image that includes the face of a predetermined person with a specific face expression;

a first face characteristic point extraction means for extracting characteristic points that indicate the contours of face components forming the face in the registered face image;

an image input means for accepting input of a detection target image;

a face image detection means for detecting a face image that includes a face from the detection target image;

a second face characteristic point extraction means for extracting characteristic points that indicate the contours of face components forming the face in the detected face image;

an index value calculation means for calculating an index value that indicates the correlation in the positions of the characteristic points by comparing the characteristic points extracted from the face in the detected face image with the characteristic points extracted from the face in the registered image; and

an expression determination means for determining whether the detected face image includes a face with an expression similar to the specific expression based on the magnitude of the index value.

In the specific expression face detection apparatus described above, the apparatus may further include a face recognition means for performing face recognition on the detected face images to select a face image that includes the face of the same person as the predetermined person from all of the detected face images, and wherein: the index value calculation means may be a means for calculating the index value by comparing the characteristic points extracted from the face in the selected face image with the characteristic points extracted from the face in the registered image; and the expression determination means may be a means for determining whether the selected face image includes a face with an expression similar to the specific expression.

Further, in the specific expression face detection apparatus described above, the image input means may be a means for accepting input of a plurality of different images, and wherein: the detection of a face image by the face image detection means, the extraction of characteristic points by the second face characteristic point extraction means, the calculation of an index value by the index value calculation means, and the determination by the expression determination means may be performed on each of the plurality of different images; and the apparatus may further includes an output means for selecting an image that includes the face image determined to include a face with an expression similar to the specific expression, and outputting information that identifies the selected image.

Still further, in the specific expression face detection apparatus described above, the detection target image may be an image obtained by an imaging means through imaging, and the apparatus may further include a notification means for outputting at least one of a sign, a voice, a sound, and light according to the determination result to notify the determination result.

An imaging control apparatus of the present invention includes:

an image registration means for accepting registration of an image that includes the face of a predetermined person with a specific face expression;

a first face characteristic point extraction means for extracting characteristic points that indicate the contours of face components forming the face in the registered face image;

an image input means for accepting input of a preliminarily recorded image obtained by an imaging means through preliminary imaging;

a face image detection means for detecting a face image that includes a face from the preliminarily recorded image;

a second face characteristic point extraction means for extracting characteristic points that indicate the contours of face components forming the face in the detected face image;

an index value calculation means for calculating an index value that indicates the correlation in the positions of the characteristic points by comparing the characteristic points extracted from the face in the detected face image with the characteristic points extracted from the face in the registered image;

an expression determination means for determining whether the detected face image includes a face with an expression similar to the specific expression based on the magnitude of the index value; and

an imaging control means for controlling the imaging means to allow final imaging according to the determination result.

In the imaging control apparatus described above, the apparatus may further include a face recognition means for performing face recognition on the detected face images to select a face image that includes the face of the same person as the predetermined person from all of the detected face images; and wherein: the index value calculation means may be a means for calculating the index value by comparing the characteristic points extracted from the face in the selected face image with the characteristic points extracted from the face in the registered image; and the expression determination means may be a means for determining whether the selected face image includes a face with an expression similar to the specific expression.

Further, in the imaging control apparatus described above, the imaging control means may be a means for performing the control of allowing final imaging according to the determination result that the detected face image includes a face with an expression similar to the specific expression.

Still further, in the imaging control apparatus described above, the imaging control means may be a means for performing the control of allowing final imaging according to the determination result that the detected face image does not include a face with an expression similar to the specific expression.

A program of the present invention (first program) is a program for causing a computer to function as a specific expression face detection apparatus by causing the computer to function as:

an image registration means for accepting registration of an image that includes the face of a predetermined person with a specific face expression;

a first face characteristic point extraction means for extracting characteristic points that indicate the contours of face components forming the face in the registered face image;

an image input means for accepting input of a detection target image;

a face image detection means for detecting a face image that includes a face from the detection target image;

a second face characteristic point extraction means for extracting characteristic points that indicate the contours of face components forming the face in the detected face image;

an index value calculation means for calculating an index value that indicates the correlation in the positions of the characteristic points by comparing the characteristic points extracted from the face in the detected face image with the characteristic points extracted from the face in the registered image; and

an expression determination means for determining whether the detected face image includes a face with an expression similar to the specific expression based on the magnitude of the index value.

In the program of the present invention described above, the program may cause the computer to further function as a face recognition means for performing face recognition on the detected face images to select a face image that includes the face of the same person as the predetermined person from all of the detected face images, and wherein: the index value calculation means may be a means for calculating the index value by comparing the characteristic points extracted from the face in the selected face image with the characteristic points extracted from the face in the registered image; and the expression determination means may be a means for determining whether the selected face image includes a face with an expression similar to the specific expression.

Further, in the program of the present invention described above, the image input means may be a means for accepting input of a plurality of different images, and wherein: the detection of a face image by the face image detection means, the extraction of characteristic points by the second face characteristic point extraction means, the calculation of an index value by the index value calculation means, and the determination by the expression determination means may be performed on each of the plurality of different images; and the program may cause the computer to further function as an output means for selecting an image that includes the face image determined to include a face with an expression similar to the specific expression, and outputting information that identifies the selected image.

Still further, in the program of the present invention described above, the detection target image may be an image obtained by an imaging means through imaging, and the program may cause the computer to further function as a notification means for outputting at least one of a sign, a voice, a sound, and light according to the determination result to notify the determination result.

Another program of the present invention (second program) is a program for causing a computer to function as an imaging control apparatus by causing the computer to function as:

an image registration means for accepting registration of an image that includes the face of a predetermined person with a specific face expression;

a first face characteristic point extraction means for extracting characteristic points that indicate the contours of face components forming the face in the registered face image;

an image input means for accepting input of a preliminarily recorded image obtained by an imaging means through preliminary imaging;

a face image detection means for detecting a face image that includes a face from the preliminarily recorded image;

a second face characteristic point extraction means for extracting characteristic points that indicate the contours of face components forming the face in the detected face image;

an index value calculation means for calculating an index value that indicates the correlation in the positions of the characteristic points by comparing the characteristic points extracted from the face in the detected face image with the characteristic points extracted from the face in the registered image;

an expression determination means for determining whether the detected face image includes a face with an expression similar to the specific expression based on the magnitude of the index value; and

an imaging control means for controlling the imaging means to allow final imaging according to the determination result.

In the program of the present invention described above, the program may cause the computer to further function as a face recognition means for performing face recognition on the detected face images to select a face image that includes the face of the same person as the predetermined person from all of the detected face images, and wherein: the index value calculation means may be a means for calculating the index value by comparing the characteristic points extracted from the face in the selected face image with the characteristic points extracted from the face in the registered image; and the expression determination means may be a means for determining whether the selected face image includes a face with an expression similar to the specific expression.

In the program of the present invention described above, the imaging control means may be a means for performing the control of allowing final imaging according to the determination result that the detected face image includes a face with an expression similar to the specific expression.

Further, in the program of the present invention described above, the imaging control means may be a means for performing the control of allowing final imaging according to the determination result that the detected face image does not include a face with an expression similar to the specific expression.

The referent of “imaging means” as used herein means a means for digitally obtaining an image of a subject, which may include, for example, an imaging means that employs an optical system, such as lenses and the like, and an imaging device, such as a CMOS device or the like.

The referent of “preliminary imaging” as used herein means an imaging preliminarily performed with an intention to obtain certain information prior to final imaging which is performed at an intended timing and imaging conditions of the user. It may include, for example, single-shot imaging in which an image is obtained immediately after the shutter button of an imaging device is depress halfway, or continuous imaging in which time series frame images are obtained at predetermined time intervals as in a moving picture.

According to the specific expression face detection method and apparatus of the present invention, an image that includes the face of a predetermined person with a specific face expression is registered in advance, characteristic points that indicate the contours of face components forming the face in the registered image are extracted, a face image that includes a face is extracted from a detection target image, and characteristic points that indicate the contours of face components forming the face in the detected face image. Then the characteristic points are compared and an index value that indicates the correlation in the positions of the characteristic points is calculated, and a determination is made whether the detected face image includes a face with an expression similar to the specific expression based on the magnitude of the index value. Therefore, the detection target face expressions need not be fixed, and a face with any expression may be retrieved once registered, thereby a face with any expression desired by a user may be retrieved. Further, discrimination of a specific expression of a face is not performed using the reference defined by generalizing a specific face expression but using the characteristic points extracted from actual humans as the reference, disagreement in the expression arising from the difference in the personal characteristics may also be reduced.

### BRIEF DESCRIPTION OF THE DRAWINGS

FIG. 1 is a block diagram of a specific expression face image retrieval system according to an embodiment of the present invention, illustrating the construction thereof.

FIG. 2 is a block diagram of a face image detection section 30, illustrating the construction thereof.

FIG. 3 is a block diagram of a frame model building section 40 illustrating the construction thereof.

FIG. 4 is a block diagram of a deformation section 46 in the frame model building section 40, illustrating the construction thereof FIGS. 5A and 5B are drawings for explaining the center position of eyes.

FIG. 6A is a drawing illustrating a horizontal edge detection filter.

FIG. 6B is a drawing illustrating a vertical edge detection filter.

FIG. 7 is a drawing for explaining calculation of a gradient vector.

FIG. 8A is a drawing illustrating a human face.

FIG. 8B is a drawing illustrating gradient vectors adjacent to the eyes and mouth of the person illustrated in FIG. 8A.

FIG. 9A is a histogram illustrating the magnitudes of gradient vectors prior to normalization.

FIG. 9B is a histogram illustrating the magnitudes of gradient vectors following normalization.

FIG. 9C is a histogram illustrating the magnitudes of gradient vectors, which have been pentanarized.

FIG. 9D is a histogram illustrating the magnitudes of gradient vectors, which have been pentanarized and normalized.

FIG. 10 is a drawing illustrating examples of sample images, which are known to be of faces used for learning reference data E1.

FIG. 11 is a drawing illustrating examples of sample images, which are known to be of faces used for learning reference data E2.

FIGS. 12A, 12B and 12C are drawings for illustrating the rotation of a face.

FIG. 13 is a flowchart illustrating a learning method with which reference data used for detecting characteristic points of face, eyes, inner corners of eyes, outer corners of eyes, mouth corners, eyelids, and lips.

FIG. 14 is a drawing illustrating a method in which a discriminator is derived.

FIG. 15 is a drawing for explaining stepwise deformation of a discrimination target image.

FIG. 16 is a flowchart illustrating a process performed in the face detection section 30 and the frame model building section 40.

FIG. 17 is a drawing illustrating example landmarks specified in a face.

FIGS. 18A and 18B are drawings for explaining a brightness profile defined for the landmarks.

FIG. 19 is a flowchart illustrating the flow of an image registration process.

FIG. 20 is a flowchart illustrating a process performed in the specific expression face image retrieval system.

FIG. 21 is a block diagram of the imaging apparatus according to a first embodiment of the present invention, illustrating the construction thereof.

FIG. 22 is a flowchart illustrating a process performed in the imaging apparatus according to the first embodiment.

FIG. 23 is a block diagram of the imaging apparatus according to a second embodiment of the present invention, illustrating the construction thereof.

FIG. 24 is a flowchart illustrating a process performed in the imaging apparatus according to the second embodiment.

### DESCRIPTION OF THE PREFERRED EMBODIMENTS

Hereinafter, exemplary embodiments of the present invention will be described with reference to the accompanying drawings.

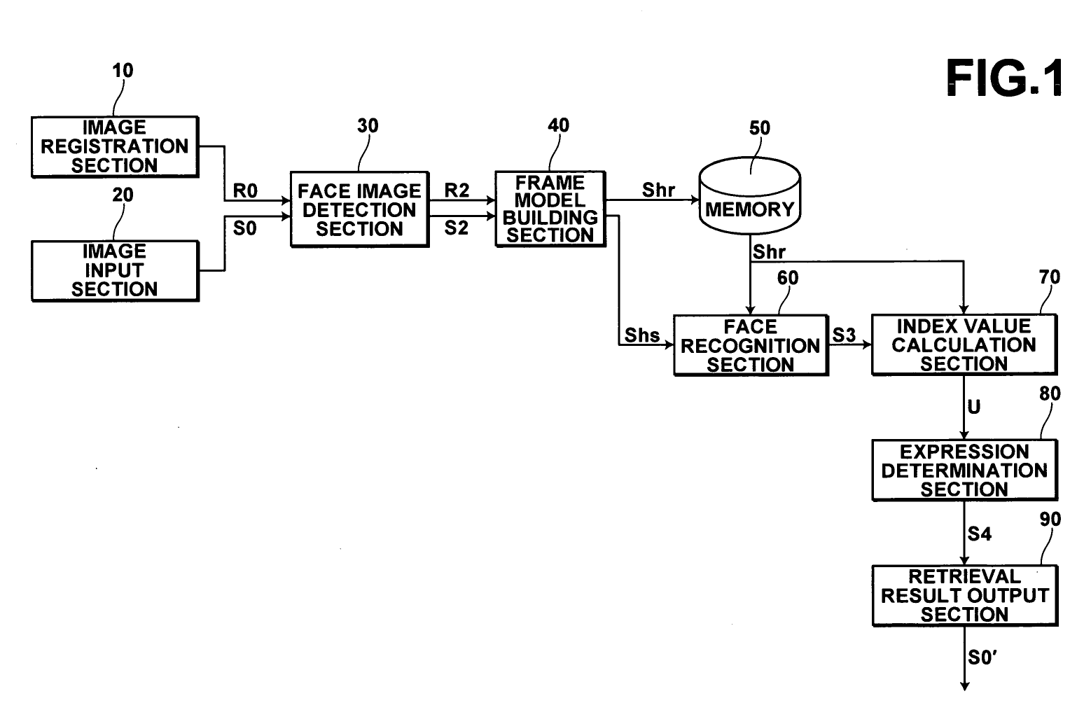

FIG. 1 is a block diagram of a specific expression face image retrieval system according to an embodiment of the present invention, illustrating the construction thereof. The specific expression face image retrieval system is a system that retrieves an image that includes the face of a predetermined person with a specific expression from a plurality of images obtained by an imaging apparatus or the like. The system is realized by executing a processing program, which is read into an auxiliary storage, on a computer (e.g., personal computer, or the like). The processing program is recorded on a CD-ROM, or distributed through a network such as the Internet, or the like, and installed on the computer. The referent of image data as used herein means data representing an image, and description will be made hereinafter without distinguishing between the image data and the image.

As shown in FIG. 1, the specific expression face image retrieval system according to the present embodiment includes: an image registration section (image registration means) 10 that accepts registration of an image R0 that includes the face of a predetermined person with a specific expression (hereinafter, image R0 is also referred to as “registered image R0); an image input section (image input means) 20 that accepts input of a plurality of different images S0, which are retrieval target images (hereinafter, the image S0 is also referred to as “input image S0”); a face image detection section (face image detection means) 30 that detects a face image R2 that includes a face portion from the registered image R0 (hereinafter, the face image R2 is also referred to as “registered face image R2”), and detects all face images S2 that include face portions from the input images S0 (hereinafter, the face image S2 is also referred to as “detected face image S2”); and a frame model building section (face characteristic point extraction means) 40 that obtains a frame model Shr that includes the characteristic points that indicate the contours of face components forming the face in the registered face image R2, and a frame model Shs that includes the characteristic points that indicate the contours of face components forming the face in detected face image S2. The system further includes: a memory 50 that stores data of the frame model Shr; a face recognition section (face recognition means) 60 that performs face recognition on the detected face images S2 to select an image S3 that includes the face of the same person as the predetermined person from all of the detected face images S2; an index value calculation section (index value calculation means) 70 that calculates an index value U that indicates the correlation in the positions of the characteristic points by comparing a frame model Shsa that includes the characteristic points extracted from the selected face image S3 and the frame model Shr that includes the characteristic points extracted from the registered face image R2; an expression determination section (expression determination means) 80 that determines whether the selected face image S3 includes a face with the expression similar to the specific expression described above based on the magnitude of the index value U; a retrieval result output section (output means) 90 that selects an image S0′ that includes a face image S4 determined to include a face with an expression similar to the specific expression from among the plurality of different images S0, and outputs information identifying the selected image S0′.

The image registration section 10 is a section that accepts registration of an image that includes a predetermined human face with a specific expression inputted by the user. The user registers an image that includes, for example, a certain child's face with smiling through the image registration section 10.

The image input section 20 is a section that accepts input of a plurality of different images S0, which are the retrieval target images, inputted by the user. The user registers, for example, a plurality of snapshots obtained by a digital camera through the image input section 20.

The face image detection section 30 is a section that reads out the registered image R0 stored in the memory 50, or the input image S0, and detects a face image from each of these images. At the time of image registration, it detects the face image R2 that includes a face portion from the registered image R0, and at the time of image retrieval, it detects all of the face images S1 that include face portions from each input image S0. The specific construction of the face image detection section 30 will be described later.

The frame model building section 40 is a section that normalizes the registered face image R2 and detected face image S2 by adjusting the in-plane rotation angles or the sizes (resolutions) of the images, and obtains frame models Ph that include the characteristic points that indicate the contours of face components forming the faces in the normalized images. At the time of image registration, it obtains a frame model Shr of the image from the registered face image R2 and stores the data of the frame model Shr in the memory 50, and at the time of image retrieval, it obtains a frame model Shs of the face from the detected face image S2. As for the characteristic points, for example, the inner corners of eyes, outer corners of eyes, midpoint of the contours of upper and lower eyelids, right and left mouth corners, midpoint of the contours of upper and lower lips. The specific construction of the frame model building section 40 will be described later.

The face recognition section 60 is a section that sequentially performs a face recognition process on all of the detected face images S2 detected from the image S0, and selects the face image S3 that includes the face of the same person as the predetermined person, i.e., the person with the face in the registered face image R2 from all of the detected face images S2. Various known face recognition methods may be used for the face recognition process. But, for example, the following method may be conceivable. That is, a method in which the frame model Shr that includes the characteristic points extracted from the face in the registered face image R2 is compared with the frame model Shs that includes the characteristic points extracted from the face in the detected face image S2 using the data of the frame model Shr stored in the memory 50 to obtain the difference in positional relationship, size, contour, and the like of each of the face components forming the face between the face in the registered face image R2 and the face in the detected face image S2, and if the magnitude of the difference is within a predetermined range, the detected face image S2 is determined to be the face image S3 that includes the face of the same person as in the registered face image R2.

The index value calculation section 70 calculates an index value U that indicates the correlation in the positions of the characteristic points by comparing the frame model Shsa of the face image S3 selected by the face recognition section 60 as the face image that includes the face of the same person as in the registered face image R2 with the frame model Shr of the registered face image R2 stored in the memory 50. As for the index value calculation method, for example, a method that uses the following formulae may be conceivable.

Shr=(X₁¹, X₂¹ - - - X₂ₙ₋₁¹, X₂ₙ¹) (1a)

Shsa=(X₁², X₂² - - - X₂ₙ₋₁, X₂ₙ²) (1b)
where, n:
number of landmarks (characteristic points)
Xi(1≦i≦n): X coordinate value of i^{th} landmark position
Xₙ₊₁(1≦i≦n): Y coordinate value of i^{th} landmark position

$$U = {\sum }_{i = 1}^{2 n} {weightX}_{i} \times \vert {X}_{i}^{1} - {X}_{i}^{2} \vert \qquad ( 2 )$$

where, weight Xᵢ: weighting factor of i^{th} characteristic point
(For example, large weighting factor is set to characteristic points related to vertical widths of eye and mouth (distance sensitive to change in expression.))

Another method that uses, for example, the following formulae may also be conceivable.

Dhr=(dis₁¹, dis₂¹ - - - disₘ₋₁¹, disₘ¹) (3a)

Dhsa=(dis₁², dis₂², - - - disₘ₋₁², disₘ²) (3b)

where,
Dhr: information of face components obtained from frame model Shr
Dhsa: information of face components obtained from frame model Shsa
m: number of types of distances of the sizes and positions of face components obtained from landmarks disj(1≦j≦m): distance related to size/position of j^{th} face part (horizontal or vertical eye length, horizontal or vertical mouth length, distance between eyes and mouth, etc.)

$$U = {\sum }_{j = 1}^{m} {weightDis}_{j} \times \frac{{dis}_{j}^{1}}{{dis}_{j}^{2}} \qquad ( 4 )$$

where, weightDisⱼ: weighting factor of j^{th} distance
(For example, large weighting factors are set to the distances related to vertical widths of eye and mouth (distances sensitive to change in expression.)

The index value U may be calculated through combination of the two methods described above.

The expression determination section 80 determines whether the selected face image S3 includes a face with the expression similar to the specific expression described above, i.e., the expression of the face in the registered face image R2 based on the magnitude of the index value U calculated by the index value calculation section 70. If the index value U is greater than or equal to a predetermined threshold value Th, the face image S3 is determined to be a face image S4 that includes a face with the expression similar to the expression of the face in the registered face image R2.

The retrieval result output section 90 selects an image S0′ that includes the face image S4 determined to include a face with the expression similar to the expression of the face in the registered face image R2, and outputs information identifying the selected image S0′. For example, it displays image data representing the image S0′, the file name of the image data, number assigned thereto at the time of inputting, a thumbnail image, or the like on an image display section (not shown).

The specific constructions of the face image detection section 30 and the frame model building section 40 will now be described. Here, the description will be made of a case in which a face image S2 that includes a face portion is detected from an input image S0, and a frame model Shs that includes characteristic points of the face is extracted from the face image S2.

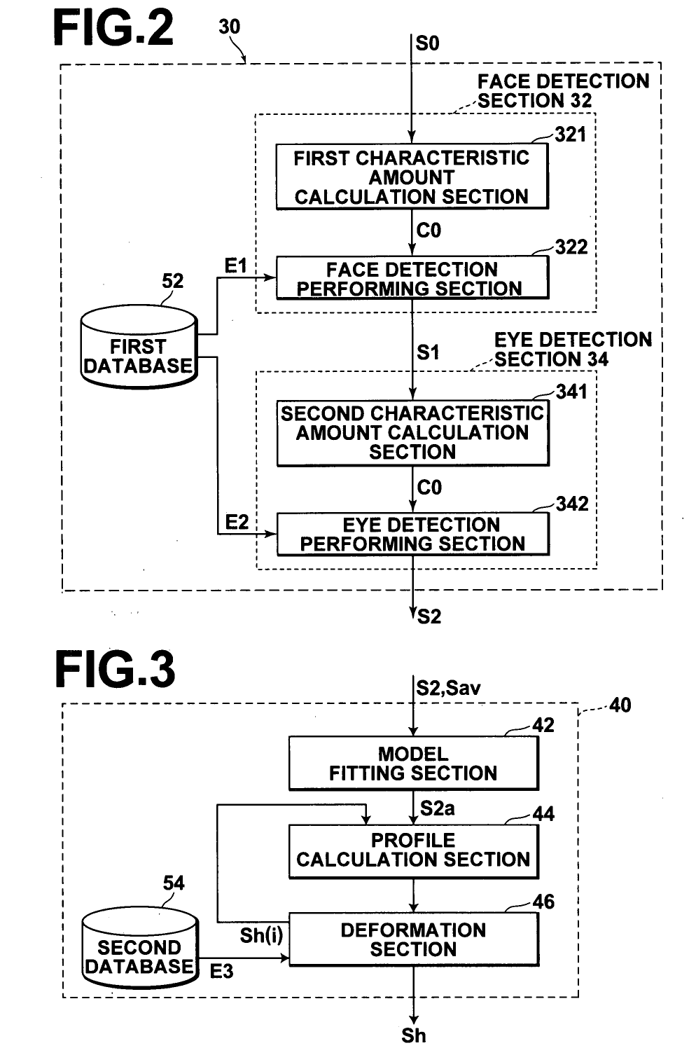

FIG. 2 is a block diagram of the face image detection section 30, illustrating the construction thereof. The face image detection section 30 includes: a face detection section 32 that detects a face from the image S0 to obtain a face image S1; an eye detection section 34 that detects the positions of the eyes using the face image S1 to obtain the face image S2; and a first database 52 that stores reference data E1 used by the face detection section 32, and reference data E2 used by the eye detection section 34.

The face detection section 32 determines whether a face is included in the image S0, and if included, it detects the approximate location and size of the face, and extracts an image of the region indicated by the approximate location and size from the image S0 to obtain the face image S. As shown in FIG. 2, the face detection section 32 includes: a first characteristic amount calculation section 321 that calculates a characteristic amount C0 from the image S0; and a face detection performing section 322 that performs face detection using the characteristic amount C0 and the reference data E1 stored in the first database 52. The structures of the reference data E1 stored in the first database 52 and the construction of each of the sections will now be described in detail.

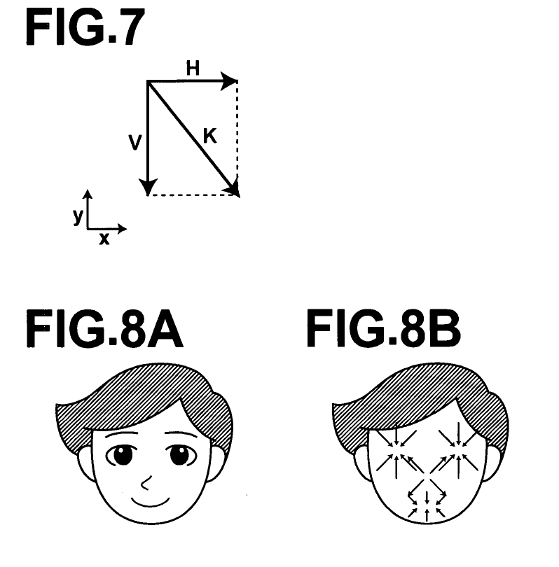

The first characteristic amount calculation section 321 of the face detection section 32 calculates the characteristic amount C0 used for face discrimination from the image S0. More specifically, it calculates a gradient vector (the direction and amount of change of density with respect to each pixel in the image S0) as the characteristic amount C0. The calculation of the gradient vector will now be described. First, the first characteristic amount calculation section 321 performs filtering on the image S0 using a horizontal edge detection filter shown in FIG. 6A to detect a horizontal edge in the image S0. Further, it performs filtering on the image S0 using a vertical edge detection filter shown in FIG. 6B to detect a vertical edge in the image S0. Then, as shown in FIG. 7, a gradient vector K with respect of each pixel is calculated from the edge size H of the horizontal edge and the edge size V of the vertical edge with respect of each pixel in the image S0.

In the case of a human face shown in FIG. 8A, the gradient vectors K, which are calculated in the manner described above, are directed toward the centers of the eyes and mouth, which are dark, and are directed away from the nose, which is bright, as illustrated in FIG. 8B. In addition, the magnitudes of the gradient vectors K are greater for the eyes than for the mouth, because changes in the density are greater for the eyes than for the mouth.

The directions and magnitudes of the gradient vectors K are defined as the characteristic amount C0. The direction of the gradient vector takes a value between 0 to 359 degrees with reference to a predetermined direction of the gradient vector K (x direction in FIG. 7, for example).

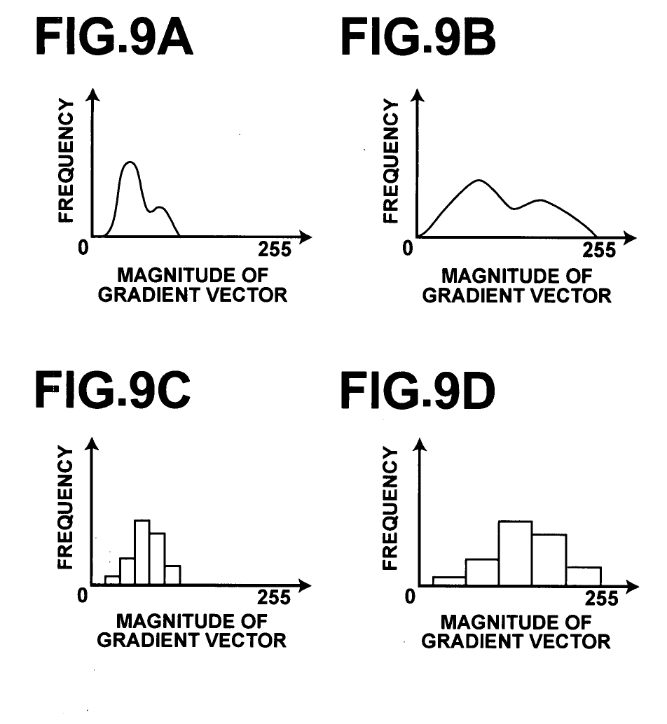

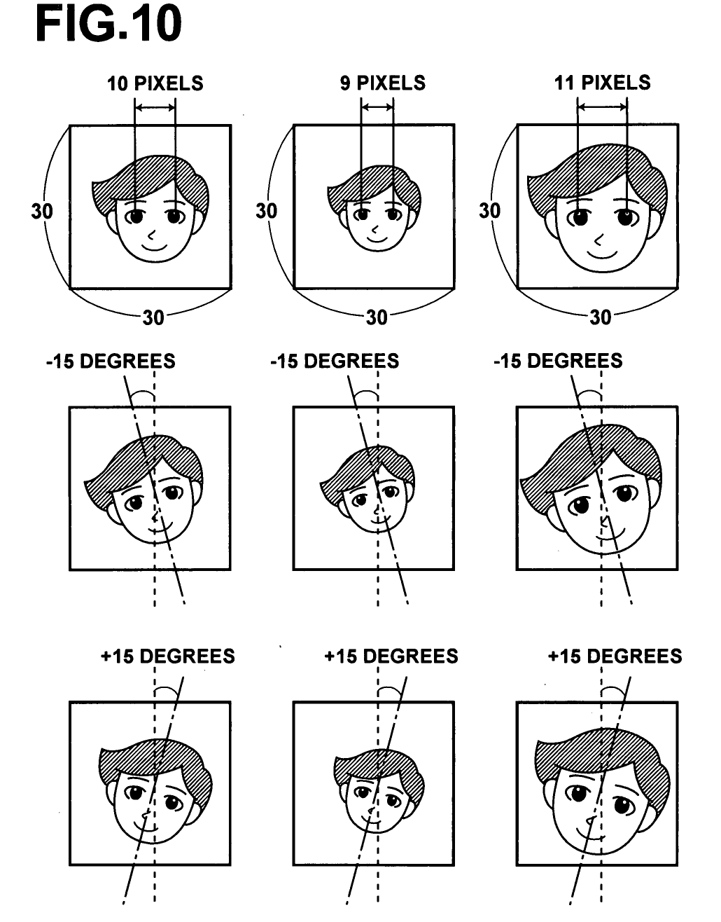

Here, the magnitudes of the gradient vectors K are normalized. The normalization is performed in the following manner. First, a histogram that represents the magnitudes of the gradient vectors K of all of the pixels within the image S0 is derived. Then, the magnitudes of the gradient vectors K are corrected, by flattening the histogram so that the distribution of the magnitudes is evenly distributed across the range of values assumable by each pixel of the image S0 (0 through 255 in the case that the image data is 8 bit data). For example, in the case that the magnitudes of the gradient vectors K are small and concentrated at the low value side of the histogram as illustrated in FIG. 9A, the histogram is redistributed so that the magnitudes are distributed across the entire range from 0 through 255, as illustrated in FIG. 9B. Note that, it is preferable that the distribution range of the gradient vectors K in a histogram be divided, for example, into five as illustrated in FIG. 9C in order to reduce the amount of calculations. Then, the gradient vectors K are normalized by redistributing the histogram such that the frequency distribution, which has been divided into five, is distributed across the entire range of values from 0 through 255, as illustrated in FIG. 9D.

The reference data E1 stored in the first database 52 are the data that prescribe discrimination conditions for combinations of the characteristic amounts C0 for each pixel of each of a plurality of types of pixel groups, which are constituted by a plurality of pixels selected from sample images, to be described later.

The combinations of the characteristic amounts C0 and the discrimination conditions for each pixel of each of the pixel groups in the reference data E1 are set in advance by learning. The learning is performed by employing an image group comprising a plurality of sample images, which are known to be of faces, and a plurality of sample images, which are known to not be of faces.

In the present embodiment, the following sample images are used, as the sample images known to be of faces, to generate the reference data E1. That is, the sample images are of a 30×30 pixel size, the distances between the centers of the eyes of each face within the images are one of 9, 10, or 11 pixels, and the faces are rotated stepwise within the plane of the drawing in three degree increments within a range of ±15 degrees from the vertical (that is, the rotational angles are −15 degrees, −12 degrees, −9 degrees, −6 degrees, −3 degrees, 0 degrees, 3 degrees, 6 degrees, 9 degrees, 12 degrees, and 15 degrees) as shown in FIG. 10. Accordingly, 33 sample images (3×11) are prepared for each face. Note that only sample images which are rotated −15 degrees, 0 degrees, and 15 degrees are illustrated in FIG. 10. The centers of rotation are the intersections of the diagonals of the sample images. Here, the center positions of the eyes are the same for all of the sample images in which the distance between the centers of the eyes is 10 pixels. The center positions of the eyes are expressed as (x1, y1) and (x2, y2) in the coordinate space with the origin located at the top left corner of the sample images. The positions of the eyes (i.e., y1 and y2) in the vertical direction in the drawing are the same for all of the sample images.

As for the sample images known to not be of faces, arbitrary images of a size of 30×30 pixels are employed.

Consider a case in which sample images, in which the distance between the eyes are 10 pixels and the rotational angle is 0 degrees (that is, the faces are in the vertical orientation), are employed exclusively to perform learning. In this case, only those faces, in which the distance between the eyes are 10 pixels and which are not rotated at all, would be discriminated by referring to the reference data E1. The sizes of the faces, which are possibly included in the images S0, are not uniform in size. Therefore, during discrimination whether a face is included in the image S0, it is enlarged/reduced, to enable discrimination of a face of a size that matches that of the sample images. However, in order to maintain the distance between the centers of the eyes accurately at ten pixels, it is necessary to enlarge or reduce the image S0 in a stepwise manner with a magnification rate of 1.1, which results in a great amount of calculations.

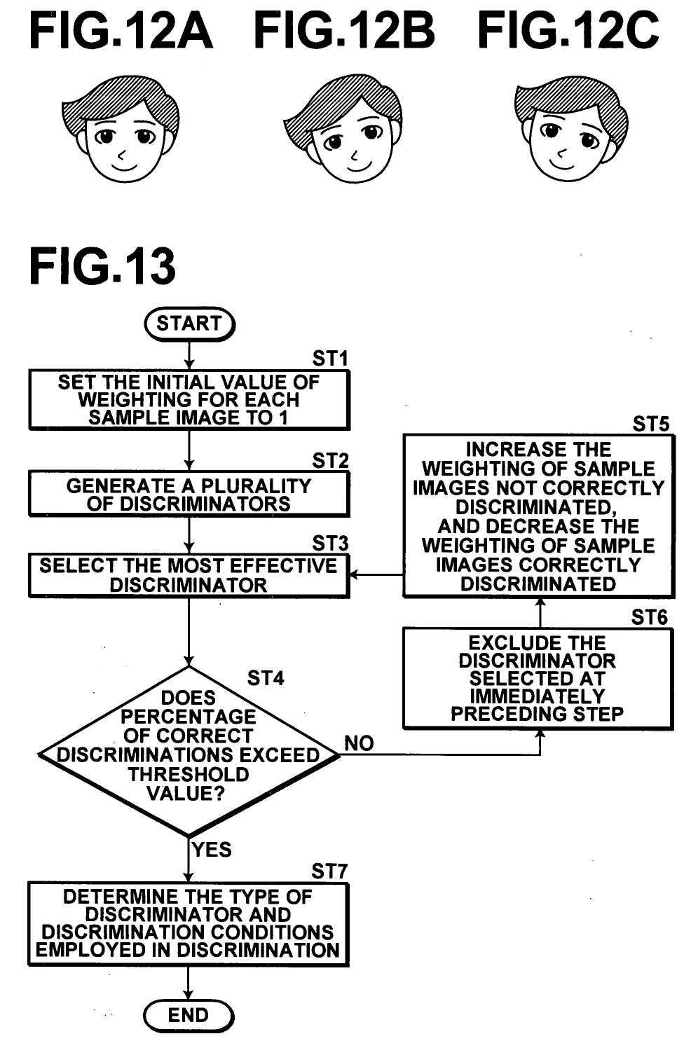

In addition, faces possibly included in the image S0 are not only those which have rotational angles of 0 degrees, as that illustrated in FIG. 12A. There are cases in which the faces in the images S0 are rotated, as illustrated in FIGS. 12B, 12C. However, in the case that sample images, in which the distance between the eyes are 10 pixels and the rotational angle is 0 degrees, are employed exclusively to perform learning, rotated faces such as those illustrated in FIGS. 12B, 12C would not be discriminated as faces.

For this reason, in the present embodiment, sample images in which the distances between the centers of the eyes are 9, 10, and 11 pixels, and which are rotated in a stepwise manner in three degree increments within a range of ±15 degrees are used as the sample images known to be of faces. Thereby, the image S0 may be enlarged or reduced in a stepwise manner with a magnification rate of 11/9, which enables reduction of the time required for calculations, compared to a case in which the image S0 is enlarged or reduced with a magnification rate of 1.1. In addition, rotated faces, such as those illustrated in FIGS. 12B, 12C, are also enabled to be discriminated.

Hereinafter, an example of a learning technique employing the sample images will be described with reference to the flowchart of FIG. 13.

The sample image group, which is the subject of learning, comprises a plurality of sample images, which are known to be of faces, and a plurality of sample images, which are known to not be of faces. Here, as the sample images known to be of faces, sample images in which the distances between the centers of the eyes of each face within the images are one of 9, 10, or 11 pixels, and the faces are rotated within the plane of the drawing stepwise in three degree increments within a range of ±15 degrees from the vertical are used. Each sample image is weighted, that is, is assigned a level of importance. First, the initial value of weighting for each sample image is set equally to 1 (step ST1).

Next, discriminators are generated for each of the different types of pixel groups of the sample images (step ST2). Here, each discriminator has a function of providing a reference to discriminate images of faces from those not of faces, by employing combinations of the characteristic amounts C0, for each pixel that constitutes a single pixel group. In the present embodiment, histograms of combinations of the characteristic amounts C0 for each pixel that constitutes a single pixel group are used as the discriminators.

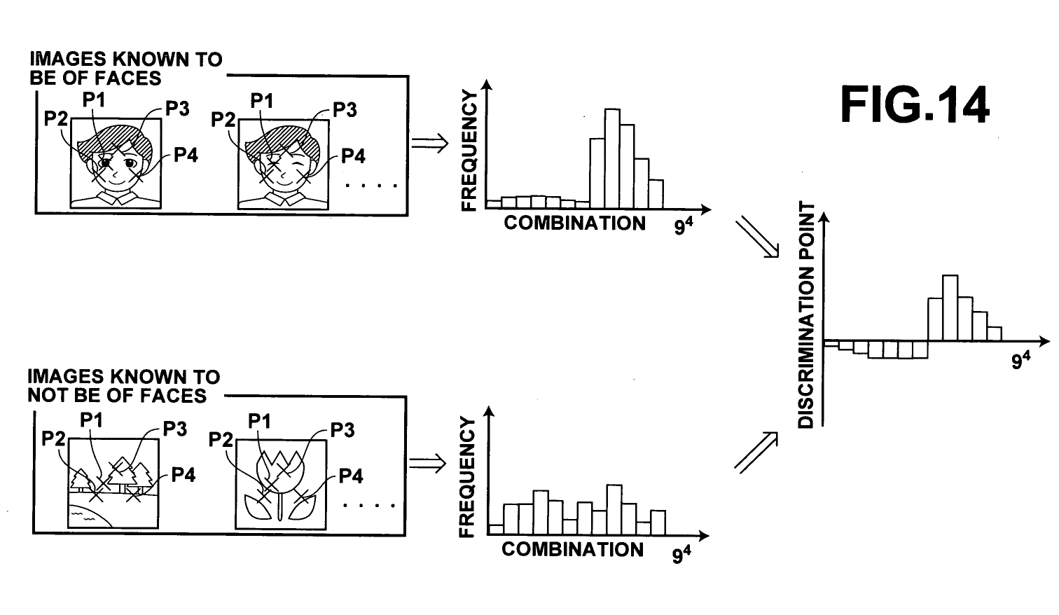

The generation of a discriminator will be described with reference to FIG. 14. As illustrated in the sample images at the left side of FIG. 14, the pixels that constitute the pixel group for generating the discriminator are: a pixel P1 at the center of the right eye; a pixel P2 within the right cheek; a pixel P3 within the forehead; and a pixel P4 within the left cheek, of the sample images which are known to be of faces. Combinations of the characteristic amounts C0 of the pixels P1 through P4 are obtained for all of the sample images, which are known to be of faces, and histograms thereof are generated. Here, the characteristic amounts C0 represent the directions and magnitudes of the gradient vectors K. However, there are 360 possible values (0 through 359) for the direction of the gradient vector K, and 256 possible values (0 through 255) for the magnitude thereof. If these values are employed as they are, the number of combinations would be four pixels at 360×256 per pixel, or (360×256)⁴, which would require large amounts of samples, time, and memory space for learning and detection. For this reason, in the present embodiment, the directions of the gradient vectors K are quaternarized, that is, set so that: values of 0 through 44 and 315 through 359 are converted to a value of 0 (right direction); values of 45 through 134 are converted to a value of 1 (upper direction); values of 135 through 224 are converted to a value of 2 (left direction); and values of 225 through 314 are converted to a value of 3 (lower direction). The magnitudes of the gradient vectors K are ternarized so that their values assume one of three values, 0 through 2. Then, the values of the combinations are calculated employing the following formulas.

Value of Combination=0 (in the case that the magnitude of the gradient vector is 0); and

Value of Combination=(direction of the gradient vector+1)×magnitude of the gradient vector (in the case that the magnitude of the gradient vector>0).

Due to the above quaternarization and ternarization, the possible number of combinations becomes 94, thereby the amount of data of the characteristic amounts C0 may be reduced.

In a similar manner, histograms are generated for the plurality of sample images, which are known to not be of faces. Note that in the sample images known to not be of faces, pixels (denoted by the same reference numerals P1 through P4) at positions corresponding to the pixels P1 through P4 of the sample images known to be of faces are employed in the calculation of the characteristic amounts C0. Logarithms of the ratios of the frequencies in the two histograms are represented by the rightmost histogram illustrated in FIG. 14, which is employed as the discriminator. Hereinafter, each value in the vertical axis of the histogram employed as the discriminator is referred to as a discrimination point. According to the discriminator, images that have distributions of the characteristic amounts C0 corresponding to positive discrimination points therein are highly likely to be of faces. The likelihood increases with an increase in the absolute values of the discrimination points. In the mean time, images that have distributions of the characteristic amounts C0 corresponding to negative discrimination points of the discriminator are highly likely to be not of faces. Again, the likelihood that an image is not of a face increases with an increase in the absolute value of the negative discrimination points. In step ST2, a plurality of discriminators in histogram format is generated for combinations of the characteristic amounts C0 of each pixel of the plurality of types of pixel groups which may be used for discrimination.

Thereafter, a discriminator, which is most effective in discriminating whether an image is of a face, is selected from the plurality of discriminators generated in step ST2. The selection of the most effective discriminator is performed while taking the weighting of each sample image into consideration. In this example, the percentages of correct discriminations provided by each of the discriminators are compared, and the discriminator having the highest weighted percentage of correct discriminations is selected (step ST3). That is, in the first step ST3, all of the weighting of the sample images are equal, at 1. Therefore, the discriminator that correctly discriminates whether sample images are of faces with the highest frequency is simply selected as the most effective discriminator. In the mean time, the weighting of each of the sample images is renewed at step ST5, to be described later, and the process returns to step ST3. Therefore, at the second step S3, there are sample images weighted with 1, those weighted with a value less than 1, and those weighted with a value greater than 1. Accordingly, during evaluation of the percentage of correct discriminations, a sample image, which has a weighting greater than 1, is counted more than a sample image, which has a weighting of 1. For these reasons, from the second and subsequent step ST3's, more importance is placed on correctly discriminating heavily weighted sample images than lightly weighted sample images.

Next, confirmation is made regarding whether the percentage of correct discriminations of a combination of the discriminators which have been selected exceeds a predetermined threshold value (step ST4). That is, the percentage of discrimination results regarding whether sample images are of faces, which are obtained by the combination of the selected discriminators, that match the actual sample images is compared against the predetermined threshold value. Here, the sample images, which are employed in the evaluation of the percentage of correct discriminations, may be those that are weighted with different values, or those that are equally weighted. In case that the percentage of correct discriminations exceeds the predetermined threshold value, whether an image is of a face can be discriminated by the selected discriminators with sufficiently high accuracy, therefore the learning process is completed. In the case that the percentage of correct discriminations is less than or equal to the predetermined threshold value, the process proceeds to step ST6, to select an additional discriminator, to be employed in combination with the discriminators which have been selected thus far.

The discriminator selected at the immediately preceding step ST3 is excluded in step ST6 so that it is not selected again.

Next, the weighting of sample images, which were not correctly discriminated by the discriminator selected at the immediately preceding step ST3, is increased, and the weighting of sample images, which were correctly discriminated, is decreased (step ST5). The reason for increasing and decreasing the weighting in this manner is to place more importance on images which were not correctly discriminated by the discriminators that have been selected thus far. In this manner, selection of a discriminator which is capable of correctly discriminating whether these sample images are of a face is encouraged, thereby improving the effect of the combination of discriminators.

Thereafter, the process returns to step ST3, and another effective discriminator is selected, using the weighted percentages of correct discriminations as a reference.

The above steps ST3 through ST6 are repeated to select discriminators corresponding to combinations of the characteristic amounts C0 for each pixel that constitutes specific pixel groups, which are suited for discriminating whether faces are included in images. If the percentages of correct discriminations, which are evaluated at step ST4, exceed the threshold value, the type of discriminator and discrimination conditions, which are to be employed in discrimination regarding whether images include faces, are determined (step ST7), and the learning of the reference data E1 is completed.

Note that in the case that the learning technique described above is applied, the discriminators are not limited to those in the histogram format. The discriminators may be of any format, as long as they provide references to discriminate between images of faces and other images by employing combinations of the characteristic amounts C0 of each pixel that constitutes specific pixel groups. Examples of alternative discriminators are: binary data, threshold values, functions, and the like. As a further alternative, a histogram that represents the distribution of difference values between the two histograms illustrated in the center of FIG. 14 may be employed, in the case that the discriminators are of the histogram format.

The learning technique is not limited to that which has been described above. Other machine learning techniques, such as a neural network technique, may be employed.

The face detection performing section 322 refers to the discrimination conditions learned by the reference data E1 for all of the combinations of the characteristic amounts C0 of each pixel that constitutes a plurality of types of pixel groups to obtain discrimination points of combinations of the characteristic amounts C0 of each pixel that constitutes each pixel group, and detects a face by totaling the discrimination points. Here, the directions and magnitudes of the gradient vectors K, which are the characteristic amounts C0, are quaternarized and ternarized respectively. In the present embodiment, all of the discrimination points are added up, and face discrimination is performed based on whether the sum of the discrimination points is positive or negative and the magnitude thereof. For example, in the case that the total sum of the discrimination points is positive, it is determined to be a face, and if the sum of the discrimination points is negative, it is determined not to be a face.

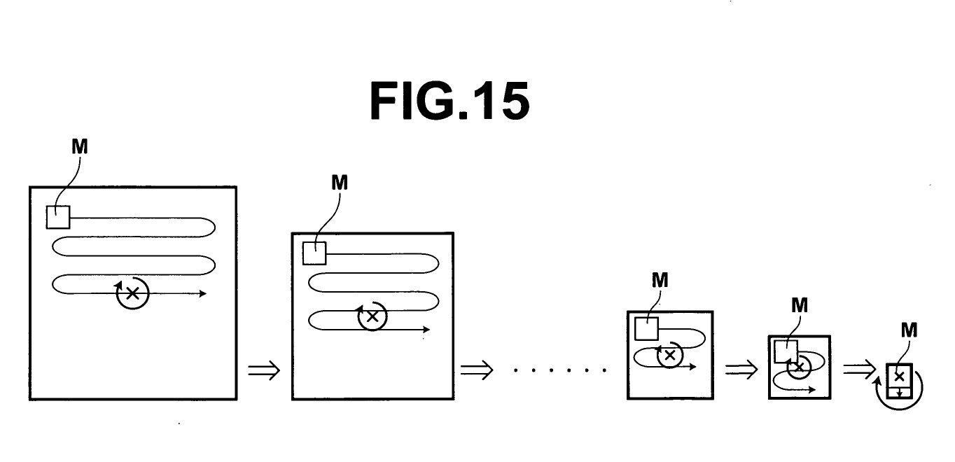

Here, the sizes of the images S0 are varied, unlike the sample images, which are 30×30 pixels. In addition, in the case that a face is included in the image S0, the face is not necessarily in the vertical orientation within the plane. For these reasons, the face detection performing section 322 enlarges/reduces the image S0 in a stepwise manner, so that the size thereof becomes 30 pixels either in the vertical or horizontal direction, as illustrated in FIG. 15. In addition, the image S0 is rotated in a stepwise manner over 360 degrees within the plane (FIG. 15 illustrates a reduction process). A mask M with a pixel size of 30×30 is set on the image S0 at each stage of enlargement/reduction. The mask M is moved one pixel at a time on the image S0, and discrimination whether the image within the mask is a face image (i.e., whether the sum of the discrimination points obtained from the image within the mask is positive or negative) is performed. The discrimination described above is performed on the image S0 at each stage of the stepwise enlargement/reduction and rotation. Thereby, from the image S0 with the size and rotation angle at the stage where a positive value for the sum of the discrimination points is obtained, a region of 30×30 pixels corresponding to the discriminated location of the mask M is detected as a face region, and the image in the detected region is extracted from the image S0 as the face image S1. If the sum of the discrimination points is negative at all of the stages, it is determined that no face is included in the image S0, and the process is terminated.

Note that when generating the reference data E1, the sample images, in which the distances between the centers of the eyes are one of 9, 10, and 11 pixels, are used for learning, so that the magnification rate during the enlargement/reduction of the image S0 may be set to be 11/9. In addition, when generating the reference data E1, sample image, in which faces are rotated within the plane within a range of ±15 degrees are used for learning, so that the image S0 may be rotated over 360 degrees in 30 degree increments.

The first characteristic amount calculation section 321 calculates the characteristic amounts C0 at each stage of the stepwise enlargement/reduction and rotational deformation of the image S0.

The face detection section 32 obtains the face image S1 by detecting the approximate location and size of a face from the image S0 in the manner as described above. Note that the face detection section 32 determines that a face is included if the sum of the discrimination points is positive, so that there may be a case in which a plurality of face images S1 is obtained by the face detection section 32.

The eye detection section 34 detects the positions of the eyes from the face image S1, obtained by the face detection section 32, to obtain the true face image S2 from a plurality of face images S1. As shown in FIG. 2, the eye detection section 34 includes: a second characteristic amount calculation section 341 that calculates a characteristic amount C0 from the face image S1; and an eye detection performing section 342 that performs detection of eye positions based on the characteristic amount C0 and reference data E2 stored in the first database 52.

In the present embodiment, the eye position discriminated by the eye detection performing section 342 is the center position between the outer corner and inner corner of each eye in a face. For the eyes oriented due front, the eye positions are identical to the center positions of the pupils as shown in FIG. 5A. For the eyes oriented to right, however, the eye positions are not the center positions of the pupils, but locate at positions in the pupils, which are displaced from the center positions thereof, or at positions in the whites of the eyes.

The second characteristic calculation section 341 is similar to the first characteristic amount calculation section 321 of the face detection section 32 shown in FIG. 2, except that it calculates a characteristic amount C0 from the face image S1 instead of the image S0. Therefore, it will not be elaborated upon further here.

The reference data E2 stored in the first database 52 are data that prescribe discrimination conditions for combinations of the characteristic amounts C0 for each pixel of each of a plurality of types of pixel groups, which are constituted by a plurality of pixels selected from sample images, to be described later, as the reference data E1.

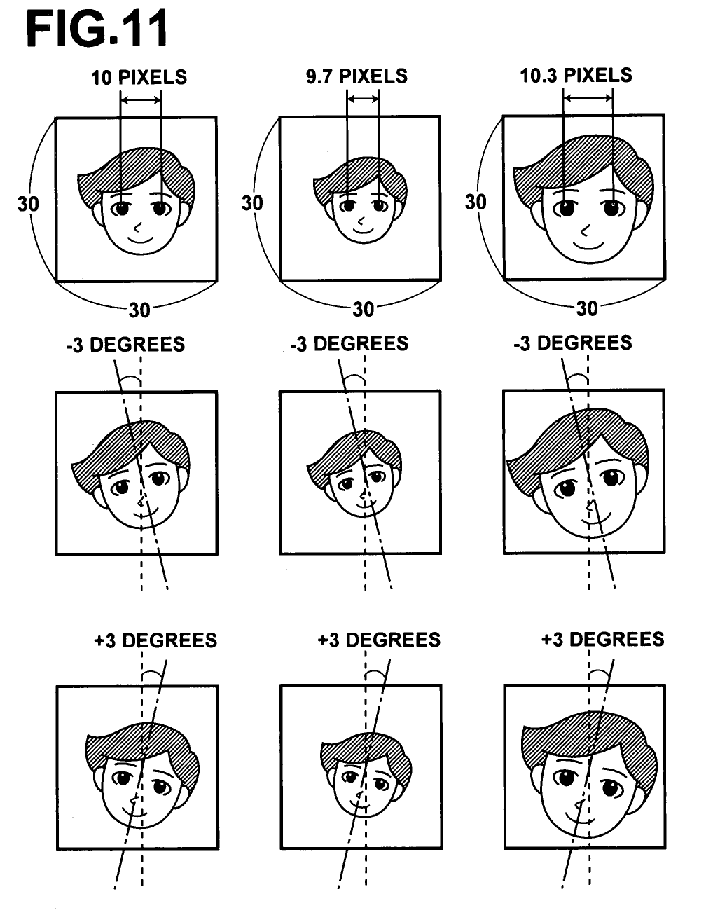

Here, as shown in FIG. 11, sample images in which the distances between the centers of the eyes of each face within the images are one of 9.7, 10, or 10.3 pixels, and the faces are rotated stepwise within the plane of the drawing in one degree increments within a range of ±3 degrees from the vertical are used for the learning of the reference data E2. Therefore, the allowable range in the learning of the reference data E2 is smaller compared to the allowable range of the reference data E1, which enables accurate detection of eye positions. The learning technique used for obtaining the reference data E2 is similar to the learning technique used for obtaining the reference data E1, except that it uses a different sample image group. Therefore, the learning technique used for obtaining the reference data E2 will not be elaborated upon further here.

The eye detection performing section 342 refers to the discrimination conditions learned by the reference data E2 for all of the characteristic amounts C0 of each pixel that constitutes a plurality of types of pixel groups to obtain discrimination points of combinations of the characteristic amounts C0 of each pixel that constitutes each pixel group in the face image S1 obtained by the face detection section 32, and discriminates the positions of the eyes of the face in the face image S1 by totaling the discrimination points. Here, the directions and magnitudes of the gradient vectors K, which are the characteristic amounts C0, are quaternarized and ternarized respectively.

Here, the eye detection performing section 342 enlarges/reduces the face image S1 in a stepwise manner. In addition, the face image S1 is rotated in a stepwise manner over 360 degrees within the plane. A mask M with a pixel size of 30×30 is set on the face image S1 at each stage of enlargement/reduction. The mask is moved one pixel at a time on the face image S1, and the positions of the eyes within the mask are detected. The detection described above is performed on the face image S1 at each stage of the stepwise enlargement/reduction and rotation.

Note that when generating the reference data E2, the sample images, in which the distances between the centers of the eyes are one of 9.7, 10, and 10.3 pixels, are used for learning, so that the magnification rate during the enlargement/reduction of the face image S1 may be set to be 10.3/9.7. In addition, when generating the reference data E2, sample image, in which faces are rotated within the plane within a range of ±3 degrees are used for learning, so that the face image S1 may be rotated over 360 degrees in 6 degree increments.

The second characteristic amount calculation section 341 calculates the characteristic amounts C0 at each stage of the stepwise enlargement/reduction and rotational deformation of the face image S1.

In the present embodiment, the discrimination points at each stage of deformation of the face image S1 are added up for each of all of the face images S1 obtained by the face detection section 32 to discriminate the face image S1 having the highest sum of the discrimination points. Then, in the image within the 30×30 pixel size mask M of the discriminated face image S1 at the deformation stage, a coordinate system is set with the origin located at the upper left corner of the image, and the positions corresponding to the coordinates of the positions of the eyes (x1, y1) and (x2, y2) of the image are obtained, and positions corresponding to these positions in the face image S1, prior to deformation thereof, are discriminated as the positions of the eyes.

In this way, the eye detection section 34 detects the positions of the eyes from one of the face images S1 obtained by the face detection section 32, and outputs the face image S1 used to detect the positions of the eyes to the frame model building section 40 as the true face image S2, together with the positions of the eyes.

FIG. 3 is a block diagram of the frame model building section 40 illustrating the construction thereof. The frame model building section 40 is a section that obtains a frame model Sh of the face in the face image S2 obtained by the eye detection section 34 using an average frame model Sav and reference data E3 stored in a second database 54. As shown in FIG. 3, the frame model building section 40 includes: the second database 54; a model fitting section 42 that fits the average frame model Sav into the face image S2; a profile calculation section 44 that calculates a profile for discriminating each landmark; and a deformation section 46 that deforms the average frame model Sav based on a brightness profile calculated by the profile calculation section 44 and the reference data E3 to obtain the frame model Sh.

The statistical model known as ASM (active shape model) used for obtaining the frame model will now be described. The statistical model, ASM is described, for example, in Japanese Unexamined Patent Publication No. 2004-527863, and a non-patent literature “The Use of Active Shape Models for Locating Structures in Medical Images” by T. F. Cootes, A. Hill, C. J. Taylor, and J. Haslam; Image and Vision Computing, pp. 276-286, 1994. The ASM may indicate the location, shape, and size of each component of a predetermined object, such as cheek, eye, mouth and the like forming a face. In the ASM method, as shown in FIG. 17, first the positions of a plurality of landmarks indicating the position, shape and size of each component of a predetermined object (a face in the illustrated example) are specified on each of a plurality of sample images of the predetermined object to obtain a frame model of each sample image. The frame model is formed by connecting the points of landmarks according to a predetermined rule. For example, when the predetermined object is a face, the points on the face contour, points on the lines of the eyebrows, points on the contours of the eyes, points on the pupils, points on the lines of upper and lower lips, and the like are specified as the landmarks. The frame formed by connecting the landmark points on the respective components with each other, such as those on the face contour, those on the lines of the lips, and the like is the frame model of the face. Frame models obtained by the plurality of sample images are averaged to obtain an average frame model. The position of each landmark on the average frame model is the average position of the corresponding positions on the respective sample images. For example, in a case where 130 landmarks are used for a face, and the 110^{th} land mark indicates the tip of the chin, the position of the 110^{th} landmark on the average frame model is an average position obtained by averaging the positions of 110^{th} landmark, which indicates the tip of the chin, specified in the respective sample images. In the ASM method, the average frame model obtained in the manner as described above is applied to a predetermined object included in a processing target image. The position of each landmark on the applied average frame model is used as the initial value of each landmark of the predetermined object included in the processing target image, and the average frame model is gradually deformed (i.e., the position of each landmark on the average frame model is moved) so as to conform to the predetermined object included in the processing target image. In this way, the position of each landmark on the predetermined object included in the processing target image is obtained. The deformation of the average frame model will now be described.

As described above, the frame model that represents a predetermined object is indicated by the position of each landmark on the frame model. Therefore, a frame model S, if it is two-dimensional, may be represented by a vector constituted by 2n elements (n: number of landmarks) as in the following formula (5).

S=(X₁, X₂, - - - Xₙ, Xₙ₊₁, Xₙ₊₂, - - - , X₂ₙ) (5)

where,
S: frame model
n: number of landmarks
Xi (1≦i≦n): X coordinate value of i^{th} landmark position
Xₙ₊₁ (1≦i≦n): Y coordinate value of i^{th} landmark position

### Further, the average frame model Sav may be expressed as the following formula (6).

Sₐᵥ=( X̅₁, X̅₂, . . . , X̅ₙ, X̅ₙ₊₁, X̅ₙ₊₂, . . . , X̅₂ₙ) (6)

where,
Sₐᵥ average frame model
n: number of landmarks
X̅ᵢ(1≦i≦n): average X coordinate value of i^{th} landmark position
X̅ₙ₊ᵢ(1≦i≦n): average Y coordinate value of i^{th} landmark position

The matrix shown in the following formula (7) may be reduced using the frame model of each sample image and the average frame model Sav obtained from the sample images.

$$[ \begin{matrix}{\sum }_{j = 1}^{m} {( {X}_{1}^{j} - {\overline{X}}_{1} )}^{2} & {\sum }_{j = 1}^{m} ( {X}_{1}^{j} - {\overline{X}}_{1} ) ( {X}_{2}^{j} - {\overline{X}}_{2} ) & ⋯ & {\sum }_{j = 1}^{m} ( {X}_{1}^{j} - {\overline{X}}_{1} ) ( {X}_{2 n - 1}^{j} - {\overline{X}}_{2 n - 1} ) & {\sum }_{j = 1}^{m} ( {X}_{1}^{j} - {\overline{X}}_{1} ) ( {X}_{2 n}^{j} - {\overline{X}}_{2 n} ) \\ {\sum }_{j = 1}^{m} ( {X}_{1}^{j} - {\overline{X}}_{1} ) ( {X}_{2}^{j} - {\overline{X}}_{2} ) & {\sum }_{j = 1}^{m} {( {X}_{2}^{j} - {\overline{X}}_{2} )}^{2} & ⋯ & {\sum }_{j = 1}^{m} ( {X}_{2}^{j} - {\overline{X}}_{2} ) ( {X}_{2 n - 1}^{j} - {\overline{X}}_{2 n - 1} ) & {\sum }_{j = 1}^{m} ( {X}_{2}^{j} - {\overline{X}}_{2} ) ( {X}_{2 n}^{j} - {\overline{X}}_{2 n} ) \\ ⋮ & ⋮ & ⋮ & ⋮ & ⋮ \\ {\sum }_{j = 1}^{m} ( {X}_{1}^{j} - {\overline{X}}_{1} ) ( {X}_{2 n - 1}^{j} - {\overline{X}}_{2 n - 1} ) & {\sum }_{j = 1}^{m} ( {X}_{2}^{j} - {\overline{X}}_{2} ) ( {X}_{2 n - 1}^{j} - {\overline{X}}_{2 n - 1} ) & ⋯ & {\sum }_{j = 1}^{m} {( {X}_{2 n - 1}^{j} - {\overline{X}}_{2 n - 1} )}^{2} & {\sum }_{j = 1}^{m} ( {X}_{2 n - 1}^{j} - {\overline{X}}_{2 n - 1} ) ( {X}_{2 n}^{j} - {\overline{X}}_{2 n} ) \\ {\sum }_{j = 1}^{m} ( {X}_{1}^{j} - {\overline{X}}_{1} ) ( {X}_{2 n}^{j} - {\overline{X}}_{2 n} ) & {\sum }_{j = 1}^{m} ( {X}_{2}^{j} - {\overline{X}}_{2} ) ( {X}_{2 n}^{j} - {\overline{X}}_{2 n} ) & ⋯ & {\sum }_{j = 1}^{m} ( {X}_{2 n - 1}^{j} - {\overline{X}}_{2 n - 1} ) ( {X}_{2 n}^{j} - {\overline{X}}_{2 n} ) & {\sum }_{j = 1}^{m} {( {X}_{2 n}^{j} - {\overline{X}}_{2 n} )}^{2}\end{matrix} ] \qquad ( 7 )$$

where,
n: number of landmarks
m: number of sample images
Xᵢ^{j}(1≦i≦n): X coordinate value of i^{th} landmark position in j^{th} sample image
Xₙ₊ᵢ^{j}(1≦i≦n): Y coordinate value of i^{th} landmark position in j^{th} sample image
X̅ᵢ(1≦i≦n): average X coordinate value of i^{th} landmark position
X̅ₙ₊ᵢ(1≦i≦n): average Y coordinate value of i^{th} landmark position
K (1≦K≦2n) eigenvectors Pⱼ (Pⱼ₁, Pⱼ₂, - - - Pⱼ₍₂ₙ₎) (1≦j≦K), and K eigenvalues corresponding to the eigenvectors Pⱼ may be obtained from the matrix shown in formula (7). The deformation of the average frame model Sav is performed according to the following formula (8) using the eigenvectors Pⱼ.

$${S}_{h} = {S}_{av} + Δ S \\ Δ S = {\sum }_{j = 1}^{K} {b}_{j} {P}_{j} \qquad ( 8 )$$

where
Sₕ: frame model after deformation
Sₐᵥ: average frame model
ΔS: amount of movement of landmark position
K: number of eigenvectors
Pⱼ: eigenvectors
bⱼ: deformation parameter

ΔS in formula (8) indicates the moving amount for each landmark. That is, the deformation of the average frame model Sav is performed by moving the position of each landmark. As clear from formula (8), the moving amount ΔS for each landmark is obtained from the deformation parameter bⱼ and eigenvector Pⱼ. As the eigenvector Pⱼ has already been obtained, it is necessary to obtain only the deformation parameter bⱼ in order to perform deformation of the average frame model Sav. A method of obtaining the deformation parameter bⱼ will now be described.

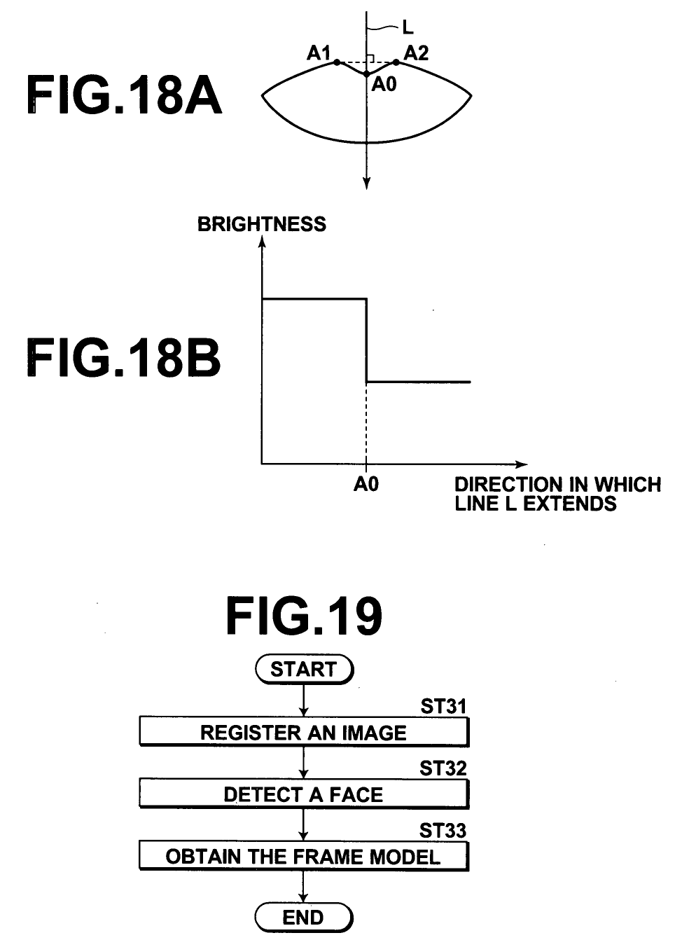

First, a characteristic amount for identifying each landmark is obtained for each landmark in each sample image in order to obtain the deformation parameter bⱼ. Here, description will be made using a landmark brightness profile as an example characteristic amount, and a landmark that indicates the depressed point of upper lip as an example landmark. A line connecting the landmarks (points A1 and A2 in FIG. 18A), each on each side of the landmark that indicates the depressed point of upper lip, that is, the center point of upper lip (point A0 in FIG. 18A) is assumed. Then the brightness profile within a small area (e.g., 11 pixels) centered on the land mark A0 on a straight line L, which is orthogonal to the line connecting the points A1 and A2, and passes through the landmark A0, is obtained as the characteristic amount of the landmark A0. FIG. 18B illustrates an example of the brightness profile, which is the characteristic amount of the landmark A0 shown in FIG. 18A.

Then, a consolidated characteristic amount for identifying the landmark that indicates the depressed point of upper lip is obtained from the brightness profile of the landmark that indicates the depressed point of upper lip in each sample image. Here, there may be differences among the characteristic amounts of the corresponding landmarks (for example, the depressed point of upper lip) in the respective sample images. But, these characteristic amounts are assumed to follow the Gaussian distribution when obtaining the consolidated characteristic amount. Methods for obtaining the consolidated characteristic amount based on the assumption of the Gaussian distribution may include, for example, an averaging method. That is, the brightness profile described above is obtained for each landmark in a plurality of sample images, and the brightness profile of the landmark corresponding to each other in the plurality of sample images is averaged, and the averaged characteristic amount is assumed to be the consolidated characteristic amount of the landmark. That is, the consolidated characteristic amount of the landmark that indicates the depressed point of upper lip is the characteristic amount obtained by averaging the brightness profile of the landmark that indicates the depressed point of upper lip in each of a plurality of sample images.

When deforming the average frame model Sav so as to conform to a predetermined object included in a processing target image, AMS performs detection in a predetermined area of the image that includes a position corresponding to a landmark on the average frame model Sav to detect a point having a characteristic amount which is most similar to the consolidated characteristic amount of the landmark. In the case of the depressed point of upper lip, for example, detection is performed within an area of the image, which is larger than the small area described above, that includes a position (first position) corresponding to the landmark that indicates the depressed point of upper lip on the average frame model Sav (e.g., the area of more than 11 pixels, for example, 21 pixels centered on the first position on a straight line in the image, which is orthogonal to the line connecting the landmarks, each on each side of the landmark that indicates the depressed point of upper lip on the average frame model) to obtain, for every 11 pixels centered on each pixel, the brightness profiles of the center pixels. Then, from these brightness profiles, a consolidated characteristic amount (average brightness profile) which is most similar to the brightness profile of the landmark that indicates the depressed point of upper lip obtained from the sample images is detected. Thereafter, based on the difference between the position having the detected brightness profile (position of the center pixel of the 11 pixels from which the brightness profile was obtained) and the first position, a moving amount required for the position of the landmark that indicates the depressed point of upper lip on the average frame model Sav is obtained, and the deformation parameter bⱼ is calculated from the moving amount. More specifically, for example, a value which is smaller than the difference described above, for example, ½ of the difference is obtained as the amount to be moved, and the deformation parameter bⱼ is calculated from the amount to be moved.

Note that, in order to prevent the case in which a face is not represented by the frame model obtained after deforming the average frame model Sav, the amounts of movement of the landmark positions are limited by limiting the deformation parameter bj with the use of eigenvalue λj as shown in the formula (9) below.

3\sqrt{λⱼ}≦bⱼ≦3\sqrt{λⱼ} (9)
where, bⱼ: deformation parameter
λⱼ: eigenvalue

In this way, ASM deforms the average frame model Sav until converged by moving each of the landmark positions on the average frame model Sav, and obtains a frame model, indicated by each of the landmark positions, of a predetermined object included in a processing target object.

The structures of the average frame model Sav, reference data E3, and construction of the frame model building section 40 will now be described in detail.

The average frame model Sav stored in the second database 54 is obtained from a plurality of sample images, which are known to be of faces. In the present embodiment, sample images of 90×90 pixel size are used, each of which is normalized such that the distance between the centers of the eyes is 30 pixels. First, positions of the landmarks which may indicate the shape of a face, the shapes of the nose, mouth, eyes, and the like of the face, and relationships thereof are specified on the sample images by the operator as shown in FIG. 17. 130 landmarks are specified on each face, by specifying, for example, the first, second, third, forth, and 110^{th} positions on the outer corner of the left eye, center of the left eye, inner corner of the left eye, center position between the eyes, and tip of the chin respectively. Then, positions of corresponding landmarks (landmarks having the same number) are averaged to obtain an average position of each landmark. The frame model Sav of formula (6) described above is formed by the average position of each landmark obtained in the manner as described above.

The second database 54 has also stored therein the sample images, K (not greater than two times the number of landmarks, here, not greater than 260, for example, 16) eigenvectors Pⱼ (Pⱼ₁, Pⱼ₂, - - - Pⱼ₍₂₀₆₎) (1≦j≦K) obtained from the average frame model Sav, and K eigenvalues λⱼ(1≦j≦K), each corresponding to each eigenvector Pⱼ. The method of obtaining the eigenvectors Pⱼ and eigenvalues λⱼ, each corresponding to each eigenvector, is identical to the conventional method. Therefore, it will not be described here.

The reference data E3 stored in the second database 54 are the data that prescribe the brightness profile defined for each landmark on a face, and discrimination conditions for the brightness profile, which are set in advance by learning. The learning is performed on the regions of faces of a plurality of sample images whose positions are known to be the positions indicated by the corresponding landmarks, and the regions of faces of a plurality of sample images whose positions are known to not be the positions indicated by the corresponding landmarks. Description will now be made of a case in which discrimination conditions for the brightness profile defined for the landmark that indicates the depressed point of upper lip.

In the present embodiment, the sample images used for obtaining the average frame model Sav are also used for generating the reference data E3. The sample images are of 90×90 pixel size, each of which is normalized such that the distance between the centers of the eyes is 30 pixels. As shown in FIG. 18A, the brightness profile defined for the landmark that indicates the depressed point of upper lip is the brightness profile of 11 pixels centered on the landmark A0 on the straight line L, which is orthogonal to the line connecting the points A1 and A2, each located on each side of the landmark A0, and passes through the landmark A0. In order to obtain discrimination conditions for the brightness profile defined for the landmark that indicates the depressed point, first, a profile at the position of the landmark that indicates the depressed point of upper lip specified on the face of each sample image is obtained. In addition, the brightness profile defined for the landmark that indicates the depressed point is also calculated for a landmark that indicates any point (e.g., outer corner of an eye) other than the depressed point of upper lip on the image of each sample image.

In order to reduce the subsequent processing time, the profiles are poly-narized, for example, quinarized. In the present embodiment, the profiles are quinarized based on the variances. More specifically, the quinarization is performed in the following manner. That is, the variance a of each of the brightness values forming a brightness profile (in the case of a brightness profile of the landmark that indicates the depressed point of upper lip, the brightness values of 11 pixels used for obtaining the brightness profile) is obtained, and the quinarization is performed in units of variance centered on an average value Yav of the brightness values. For example, the quinarization is performed such that the brightness values less than or equal to (Yav−(3/4)σ) are converted to 0, brightness values from (Yav−(3/4)σ) to (Yav−(1/4)σ) are converted to 1, brightness values from (Yav−(1/4)σ) to (Yav+(1/4)σ) are converted to 2, brightness values from (Yav+(1/4)σ) to (Yav+(3/4)σ) are converted to 3, and brightness values greater than or equal to (Yav+(3/4)σ) are converted to 4.

The discrimination conditions for discriminating the profile of the landmark that indicates the depressed point of upper lip are obtained through learning using quinarized profiles of the landmark that indicates the depressed point of upper lip of each sample image (hereinafter, a first profile group), and quinarized profiles of the landmark that indicates a point other than the depressed point of upper lip of each sample image (hereinafter, a second profile group).

The learning method of the two types of profile image groups is identical to the learning method of the reference data E1 used by the face detection section 32, and the learning method of the reference data E2 used by the eye detection section 34. Therefore, only rough description will be provided here.

First, generation of a discriminator will be described. As for one of the elements forming a single brightness profile, the shape of the brightness profile indicated by the combination of each brightness value that constitutes the brightness profile may be used. There are 5 possible brightness values, values of 0, 1, 2, 3 and 4, and there are 11 pixels in a single profile. If these values are employed as they are, the number of combinations of brightness values would be 5¹¹, which would require large amounts of time and memory for learning and detection. For this reason, in the present embodiment, only some of the pixels of a plurality of pixels forming a single brightness profile are used. For example, in the case of a profile formed of brightness values of 11 pixels, three pixels, namely the second, sixth, and tenth pixels, are used. The possible number of combinations of the brightness values of the three pixels becomes 5³, thereby reducing the calculation time and memory space. In generating the discriminator, first, combinations of brightness values described above (some of the pixels forming the profile, here, the combinations of the brightness values of the second, sixth, and tenth pixels, the same applies hereinafter) are obtained for all of the profiles of the first profile group, and then histograms are generated. Likewise, similar histograms are generated for each profile of the second profile group. Logarithms of the ratios of the frequencies in the two histograms are taken and represented by a histogram, which is the histogram used as a discriminator of the brightness profile of a landmark. According to the discriminator, if the vertical axis value (discrimination point) of the histogram thereof is positive, the position of the profile having the brightness distribution corresponding to the discrimination point is highly likely the depressed point of upper lip, and the likelihood increases with an increase in the absolute values of the discrimination points, as in the discriminator generated for detecting faces. In the mean time, if the discrimination point is negative, the position of the profile having the brightness distribution corresponding to the discrimination point is highly likely not the depressed point of upper lip, and again the likelihood increases with an increase in the absolute values of the discrimination points.

A plurality of such discriminators in histogram format is generated for the brightness profile of the landmark that indicates the depressed point of upper lip.

Thereafter, a discriminator, which is most effective in discriminating whether a landmark is the landmark that indicates the depressed point of upper lip, is selected from the plurality of discriminators. The method for selecting the most effective discriminator for discriminating the brightness profile of a landmark is similar to the selection method when generating the discriminators in the reference data E1 used by the face detection section 31, except that the discrimination target object is the brightness profile of a landmark. Therefore, it will not be elaborated further upon here.

As a result of learning the first profile group and the second profile group, the type of discriminator and discrimination conditions, which are to be employed in discrimination regarding whether a brightness profile is the brightness profile of the landmark that indicates the depressed point of upper lip, are determined.

Here, a machine learning method based on AdaBoosting scheme is used as the learning method for learning the brightness profiles of landmarks of the sample images. But the learning method is not limited to the method described above, and other machine learning methods, such as neural network technique and the like may be used.

Now, return to the description of the frame model building section 40. In order to build up the frame model of a face indicated by the face image S2 obtained from the image S0, the frame model building section 40 shown in FIG. 3 first fits the average frame model Sav stored in the second database 54 into the face in the face image S2 through the model fitting section 42. When performing the fitting of the average frame model Sav, it is preferable that the face indicated by the average frame model Sav and the face in the face image S2 is aligned as much as possible in the orientation, position, and size. Here, fitting of the average frame model Sav is performed by rotating and enlarging/reducing the face image S2 so that the positions of the landmarks that indicate the center positions of the eyes on the average frame model Sav and the positions of the eyes detected by the eye detection section 34 are aligned. A face image S2 which is rotated and enlarged/reduced when the frame model Sav is fitted is hereinafter referred to as the “face image S2a”.

The profile calculation section 44 obtains a brightness profile, which is defined for each landmark, for each pixel position in a predetermined area on the face image S2a that includes the corresponding pixel to each landmark on the average frame model Sav, thereby obtaining a profile group. For example, if the landmark that indicates the depressed point of upper lip is the 80^{th} landmark of 130 landmarks, the brightness profile like that shown in FIG. 18A (combinations of the brightness values of 11 pixels, which are included in the reference data E3) is obtained for each pixel within a predetermined area centered on the pixel (pixel A) corresponding to the 80^{th} landmark on the average frame model Sav. The referent of “predetermined area” as used herein means an area which is wider than the pixel area corresponding to brightness values forming a brightness profile included in the reference data E3. For example, the brightness profile of the 80^{th} landmark is a brightness profile of 11 pixels centered on the 80^{th} landmark on the straight line L, which is orthogonal to the line connecting the landmarks, each on each side of the 80^{th} landmark, and passes through the 80^{th} landmark, as shown in FIG. 18A. Therefore, the “predetermined area” may be an area wider than 11 pixels, e.g., 21 pixels, on the straight line L. In each pixel position within the area, a brightness profile is obtained for every consecutive 11 pixels centered on each pixel. That is, for a single landmark on the average frame model Sav, e.g., for the landmark of the depressed position of upper lip, 21 profiles are obtained from the face image S2a, which are outputted to the deformation section 45 as a profile group. Such profile group is obtained for each landmark (here, 130 landmarks). Note that all of the profiles are quinarized.

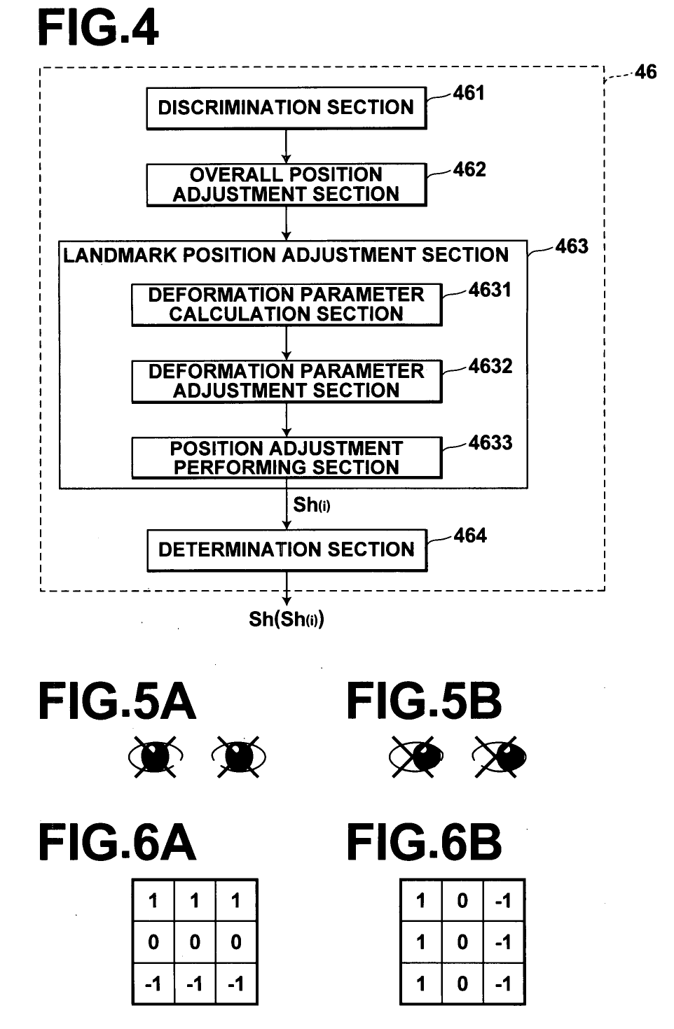

FIG. 4 is a block diagram of the deformation section illustrating the construction thereof. As shown in the drawing, the deformation section 46 includes: a discrimination section 461, overall position adjustment section 462, a landmark position adjustment section 463, and a determination section 464.

For each of the profile groups of each landmark calculated from the face image S2a by the profile calculation section 44, the discrimination section 461 first discriminates whether each profile included in each of the profile groups is the profile of the relevant landmark. More specifically, for each of the 21 profiles included in one profile group, e.g., the profile group obtained for the landmark that indicates the depressed point of upper lip (80^{th} landmark) on the average frame model Sav, discrimination is performed using the discriminators and discrimination conditions for the brightness profiles of 80^{th} landmark included in the reference data E3 to obtain discrimination points. If the sum of the discrimination points performed by each of the discriminators for a single profile is positive, it is determined that the profile is highly likely the profile of 80^{th} landmark, i.e., the pixel corresponding to the profile (center pixel of 11 pixels, i.e., sixth pixel) is highly likely the pixel indicating the 80^{th} landmark. In the mean time, if the sum of the discrimination points performed by each of the discriminators for a single profile is negative, it is determined that the profile is not the profile of the 80^{th} landmark, i.e., the pixel corresponding to the profile (center pixel of 11 pixels, i.e., sixth pixel) is not the pixel indicating the 80^{th} landmark. The discrimination section 461 discriminates the center pixel corresponding to the profile having a positive sum of the discrimination points with highest absolute value out of the 21 profiles as the 80^{th} landmark. If there is no profile that has a positive sum of the discrimination points, all of the 21 pixels corresponding to 21 profiles are determined not to be the 80^{th} landmark.

The discrimination section performs such discrimination for each landmark group, and outputs a discrimination result of each landmark group to the overall position adjustment section 462.

As described above, whereas the eye detection section 34 detects the positions of the eyes using a mask having the same pixel size as that of the sample images (30×30 pixels), the frame model building section 40 uses the average frame model Sav obtained from the sample images of 90×90 pixels in order to detect the positions of the landmarks accurately. Thus, there may be a possibility of misalignment, when only the positions of the eyes detected by the eye detection section 34 and positions of the landmarks that indicate the centers of the eyes on the average frame model Sav are aligned.

The overall position adjustment section 462 adjusts the overall position of the average frame model based on the discrimination results of the discrimination section 46. It performs linear movement, rotation, or enlargement/reduction for the entire average frame model Sav as required, so that the position, size, and orientation of the face are more aligned with the position, size, and orientation of the face indicated by the average frame model Sav, thereby reducing the misalignment. More specifically, the overall position adjustment section 47 first calculates the maximum value of the moving amount (magnitude and direction) required for each of the landmarks on the average frame model Sav. The moving amount, for example, the maximum value of the moving amount for the 80^{th} landmark, is calculated such that the position of the 80^{th} landmark on the average frame model Sav corresponds to the pixel position of 80^{th} landmark discriminated from the face image S2a by the discrimination section 46.

Then, the overall position adjustment section 462 calculates a value which is smaller than a maximum value of the moving amount for each landmark, ⅓ of a maximum value of the moving amount in the present embodiment, as the moving amount. This moving amount is obtained for each landmark, and is hereinafter represented by a vector V (v1, v2, - - - V2n), (n: number of landmarks, 130 landmarks here), which is referred to as the total moving amount.

The overall position adjustment section 462 determines whether linear movement, rotation, or enlargement/reduction is required for the average frame model Sav based on the moving amount of each landmark on the average frame model Sav calculated in the manner as described above. If required, the relevant processing is performed, and the face image S2a with the adjusted average frame model being fitted therein is outputted to the landmark position adjustment section 463, and if not required, the face image S2a is outputted to the landmark position adjustment section 463 as it is without performing overall adjustment of the average frame model Sav. For example, there may be a case in which the moving directions included in the moving amounts for the respective landmarks on the average frame model Sav are the same. In that case, it may be determined that the overall position of the average frame model Sav needs to be moved linearly in that direction. When the moving directions included in the moving amounts for the respective landmarks on the average frame model Sav are different, but if they indicate the same rotational direction, it may be determined that the average frame model Sav needs to be rotated in that rotational direction. Further, for example, if the moving directions included in the moving amounts for the respective landmarks that indicate the contour of the face are all oriented toward outside of the face, it may be determined that the average frame model Sav needs to be reduced.

The overall position adjustment section 462 globally adjusts the position of the average frame model Sav in the manner as described above, and outputs the face image S2a with the adjusted average frame model Sav being fitted therein. Here, the actually moved amount of each landmark (moving amount in overall movement) through the adjustment of the overall position adjustment section 462 is represented by a vector Vₐ (V₁ₐ, V_{2b}, - - - V₂ₙ_{_{b}}).

The landmark position adjustment section 463 deforms the average frame model Sav by moving the position of each landmark on the average frame model Sav on which the global position adjustment has been performed. The landmark position adjustment section 463 includes: a deformation parameter calculation section 4631; a deformation parameter adjustment section 4632; a position adjustment performing section 4633. First, the deformation parameter calculation section 4631 calculates a moving amount Vb (V_{1b}, V_{2b}, - - - V_{2nb}) of each landmark (moving amount in individual movement) based on the following formula (10).

V_{b}=V−Vₐ

where, V: total moving amount
Vₐ: moving amount in overall movement
V_{b}: moving amount in individual movement

The deformation parameter calculation section 4631 calculates the deformation parameter bⱼ corresponding to the moving amount in individual movement V_{b} based on formula (8) described above using eigenvector Pⱼ stored in the second database 54 and the moving amount in individual movement V_{b} (which corresponds to ΔS in formula (8)).

Here, if the moving amounts of the landmarks on the average frame model Sav are too great, the average frame model Sav after its landmarks have been moved would no longer represent a face. Therefore, the deformation parameter bⱼ calculated by the deformation parameter calculation section 4631 is adjusted by the deformation parameter adjustment section 4632 based on formula (9) described above. More specifically, if a deformation parameter bⱼ satisfies formula (9), it is left as it is, and if it does not satisfy formula (9), it is adjusted so that the value of it falls in the range indicated by formula (9) (here, it is adjusted such that the absolute value becomes maximum without changing the positive/negative sign).

The position adjustment performing section 4633 deforms the average frame model Sav by moving the position of each landmark on the average frame model Sav using the deformation parameter adjusted in the manner as described above to obtain a frame model (here, Sh (1)).

The determination section 464 determines whether the frame model is converged. For example, the absolute sum of each difference between the positions of the corresponding landmarks on the frame model prior to deformation (here, average frame model Sav) and the frame model after deformation (here, Sh (1)) (e.g., difference between the positions of 80^{th} landmarks on the two frame models) is obtained. Then, if the sum is not greater than a predetermined threshold value, the determination section 464 determines that the frame model is converged, and outputs the deformed frame model (here, Sh (1)) as an intended frame model Sh, while if the sum is greater than the threshold value, it determines that the frame model is not converged, and outputs the deformed frame model (here, Sh (1)) to the profile calculation section 44. In the latter case, the processing of the profile calculation section 44, discrimination section 461, overall position adjustment section 462, and landmark position adjustment section 463 is repeated for the previously deformed frame model (Sh (1)) and the face image S2a, thereby a new frame model Sh (2) is obtained.

As described above, a series of processing from the processing of the profile calculation section 44, through that of the discrimination section 461 to that of the position adjustment performing section 4633 of the landmark position adjustment section 463 is repeated until the frame model is converged. In this way, a converged frame model is obtained as the intended frame model Sh.

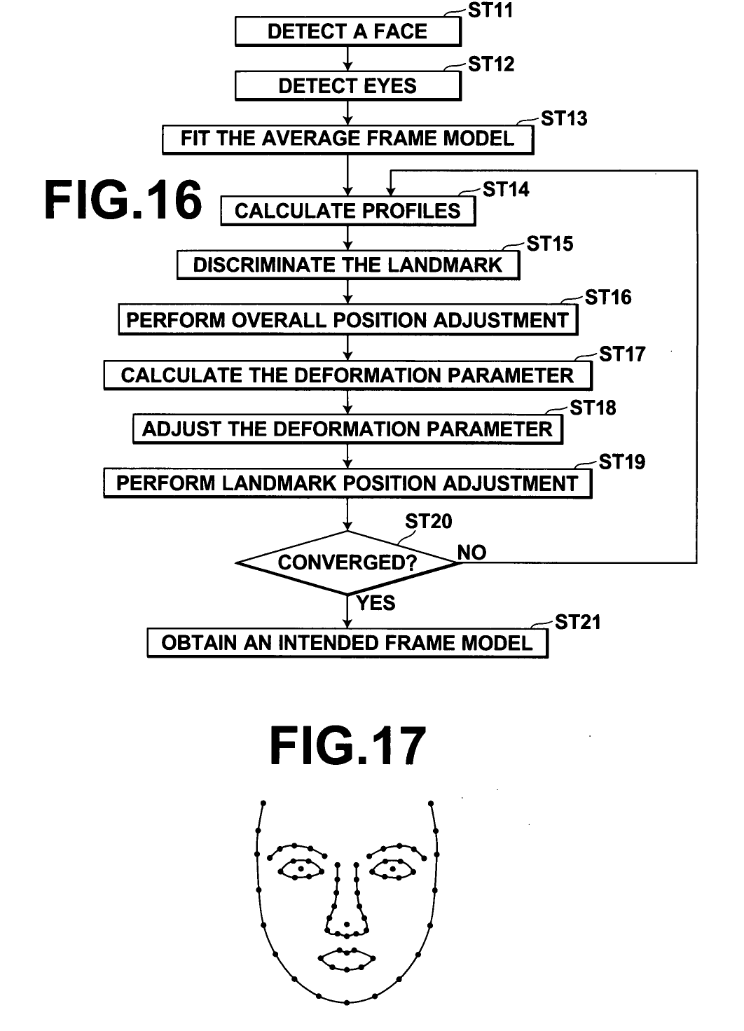

FIG. 16 is a flowchart that illustrates processes performed in the face detection section 30 and the frame model building section 40. As shown, detection of a face included in an image S0 is performed by the face detection section 32 and the eye detection section 34 to obtain the positions of the eyes of the face included in the image S0 and an image S2 of the face portion (steps ST11, ST12). An average frame model Sav obtained from a plurality of sample images stored in the second database 54 is fitted into the face image S2 by the model fitting section 42 of the frame model building section 40 (step ST13). When the average frame model Sav is fitted into the face image S2, the face image S2 is rotated or enlarged/reduced so that positions of the eyes in the face image S2 correspond to the positions of landmarks that indicate the positions of the eyes on the average frame model Sav. Here, the rotated or enlarged/reduced face image is referred to as the face image S2a. A brightness profile, which is defined for each landmark on the average frame model Sav, is obtained for each pixel position in a predetermined area on the face image S2a that includes the corresponding pixel to each landmark on the average frame model Sav by the profile calculation section 44, thereby a profile group constituted by a plurality of brightness profiles is obtained for a single landmark on the average frame model Sav (step ST14).

Among the profiles in each profile group (e.g., profile group obtained for 80^{th} landmark on the average frame model Sav), the brightness profile defined for the landmark corresponding to the profile group (e.g., 80^{th} landmark) is discriminated, and the pixel position corresponding to the discriminated profile is determined to be the position of the landmark corresponding to the profile group (e.g., 80^{th} landmark) by the discrimination section 461 of the deformation section 46. In the mean time, if neither of the brightness profiles in a single profile group is discriminated as the brightness profile defined for the landmark corresponding to the profile group, the pixel position corresponding to each of all of the brightness profiles included in the profile group is determined not to be the position of the landmark corresponding to the profile group (step ST15).

Here, the discrimination results of the discrimination section 461 are outputted to the overall position adjustment section 462, where the total moving amount V of each landmark on the average frame model Sav is obtained based on the discrimination results of the discrimination section 461 in step ST15, and the entire average frame model Sav is moved linearly, rotated, or enlarged/reduced based on the moving amount as required (step ST16). Note that the moved amount of each landmark on the average frame model Sav in step ST16 is the moving amount in overall movement Vₐ.

Then, the moving amount in individual movement V_{b} of each landmark is obtained based on the difference between the total moving amount V and the moving amount in overall movement Vₐ, and the deformation parameter corresponding to the moving amount in individual movement is obtained by the deformation parameter calculation section 4631 of the landmark position adjustment section 463 (step ST17). The deformation parameter calculated by the deformation parameter calculation section 4631 is adjusted by the deformation parameter adjustment section 4632 based on formula (5), and outputted to position adjustment performing section 4633 (step ST18). The position of each landmark is adjusted by the position adjustment performing section 4633 using the deformation parameter adjusted by the deformation parameter adjustment section 4632 in step ST18, thereby a frame model Sh (1) is obtained (step ST19).

Then, using the frame model Sh (1) and the face image S2a, the processing in steps ST14 to ST19 is performed to obtain a frame model Sh (2). In this way, the processing in steps ST14 to ST19 is repeated until the processing is determined to have been converged by the determination section 464.

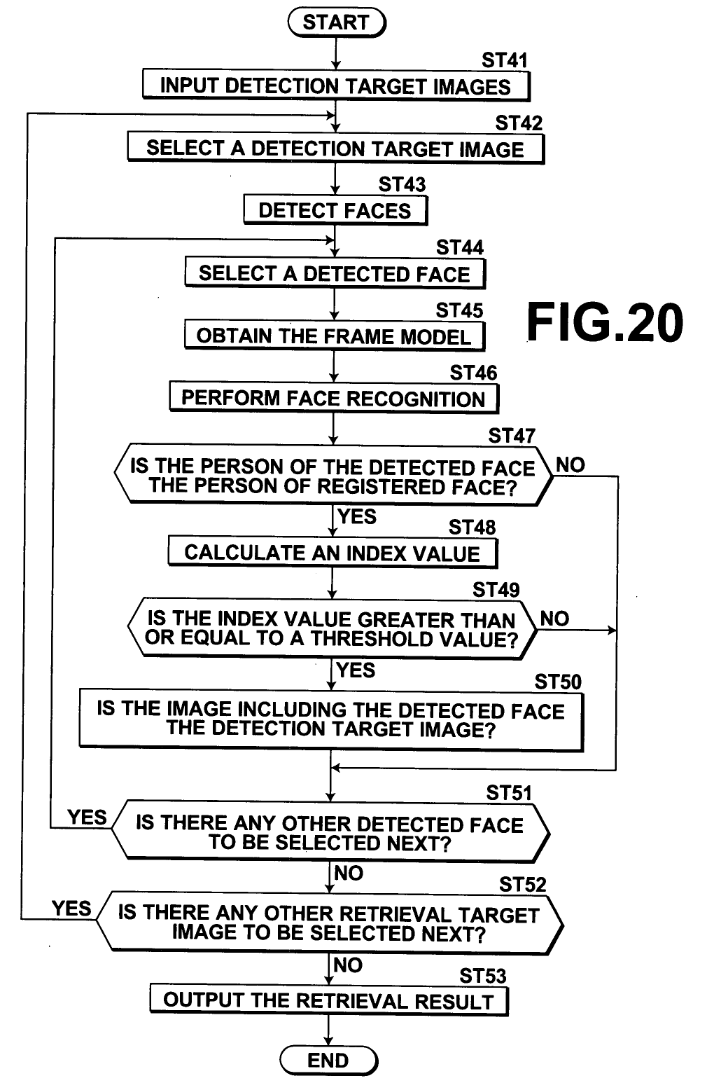

FIGS. 19 and 20 are flowcharts illustrating processes performed in the specific expression face image retrieval system according to the embodiment shown in FIG. 1. FIG. 19 is a flowchart of an image registration process for registering an image that includes the face of a predetermined person with a specific face expression in advance. FIG. 20 is a flowchart of an image retrieval process for retrieving an image that includes a face with an expression similar to the specific face expression of the predetermined person from a plurality of different images.

The flow of the image registration process will be described first. An image R0 that includes the face of a predetermined person with a specific face expression is accepted from a user by the image registration section 10, and the image R0 is stored in the memory 50 (step ST31). After the image R0 is registered, the image R0 is read out from the memory 50, and face detection is performed by the face detection section 30 to detect a face image R2 that includes the face portion (step ST32). After the face image R2 is detected, a frame model Shr that includes the characteristic points of the face included in the face image R2 is obtained by the frame model building section 40 (step ST33). Then, the frame model Shr is stored in the memory 50 as a model that defines the specific expression face of the predetermined person, and the image registration process is terminated.

Next, the flow of the image retrieval process will be described. First, when a plurality of different retrieval target images S0 is inputted, the images S0 are stored in the memory 50 by the input section 20 (step ST41). One of the plurality of different images S0 is selected (step ST42) and read out from the memory 50 to detect all of face images S2 that include face portions by performing face detection on the image S0 by the face image detection section 30 (step ST43). One of the detected face images S2 is selected (step ST44) and a frame model Shs that includes the characteristic points of the face included in the selected face image S2 is obtained by the frame model building section 40 (step ST45). The frame model Shr of the registered image R2 is read out from the database, and face recognition is performed by comparing the frame model Shr with the frame model Shs of the detected face image S2 (step ST46) to determine whether the detected face image S2 is an image S3 of the face of the same person as in the registered face image R2 by the face recognition section 60 (step ST47). If the detected face image S2 is the face image S3 of the predetermined person, the process proceeds to the next step ST48 to perform discrimination of face expression, while, if the detected face image S2 is not the image S3 of the face of the predetermined person, the process proceeds to step ST51.

In step ST48, more detailed comparison is performed between the frame model Shr of the registered face image R2 and the frame model Shs of the detected face image S3 to calculate an index value U that indicates the correlation in the positions of the characteristic points between the characteristic points of the face in the registered face image R2 and the characteristic points of the face in the detected face image S3, and a determination is made whether the index value is greater than or equal to a predetermined threshold value Th (step ST49). If the result is positive, the detected face image S3 is determined to be a face image S4 that includes a face with an expression similar to the registered specific expression. Then, the selected image S0 is selected as the intended image, i.e., an image S0′ that includes a face with an expression similar to the specific expression (step ST50), while if the determination result is negative, the process proceeds to step ST 51.

In step ST51, a determination is made whether there is any other detected face image S2 to be selected next. If the result is positive, the process returns to step ST44 to select a new detected face image S2. If the result is negative, the process proceeds to step ST52.

In step ST52, a determination is made whether there is any other retrieval target image S0. If the result is positive, the process returns to step ST42 to select the image S0, while if the determination result is negative, information that identifies images S0′ that include faces having expressions similar to the specific expression selected so far is outputted, and the image retrieval process is terminated.

As described above, according to the specific expression face image retrieval system of the present embodiment, an image that includes the face of a predetermined person with a specific face expression is registered in advance, a frame model that includes the characteristic points that indicate the contours of face components forming the face in the registered image, a face image that includes a face is detected from detection target images, a frame model that includes the characteristic points that indicate the contours of face components forming the face in the detected face image is obtained, then the two frame models are compared to each other to obtain an index value that indicates the correlation in the positions of the characteristic points, and a determination is made whether the detected face image includes a face with an expression similar to the specific expression based on the magnitude of the index value. Therefore, the detection target face expressions need not be fixed, and a face with any expression may be retrieved once registered, thereby a face with any expression desired by a user may be retrieved. Further, discrimination of a specific expression of a face is not performed using the reference defined by generalizing a specific face expression but using the characteristic points extracted from actual humans as the reference, disagreement in the expression arising from the difference in the personal characteristics may also be reduced.

Further, in the present embodiment, face recognition is performed prior to the discrimination of face expression to determine whether the detected face image includes the face of the same person as the predetermined person in a registered image, and the discrimination of face expression is performed only on the images determined to include the face of the same person. Therefore, images may be retrieved by specifying not only the face expression but also the person, so that image retrieval that further reduces the difference in expressions arising from the difference in personal characteristics may be performed.

In the present embodiment, the discrimination has been made of a case in which a single registered image R0 is provided. But, of course, a configuration may be adopted in which a plurality of images is registered, and an image that includes a face with an expression similar to that of the face in any of the registered images is retrieved.

Further, in the present embodiment, an image that includes a face with an expression similar to the registered specific expression is retrieved. But, a configuration may be adopted in which an image that does not include a face with an expression similar to the registered specific expression is retrieved.

Still further, in the present embodiment, specific expressions that may be registered include any type of expressions which are not only favorable expressions but also unfavorable expressions, such as smiling, crying, being frightened, being angry, and the like.

Hereinafter, another embodiment of the present embodiment will be described.

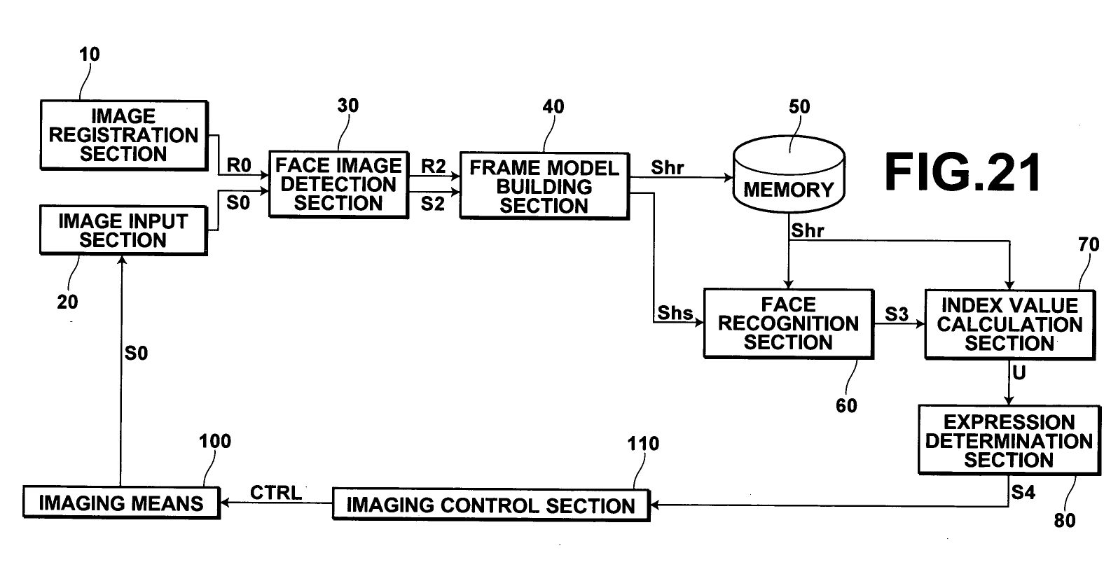

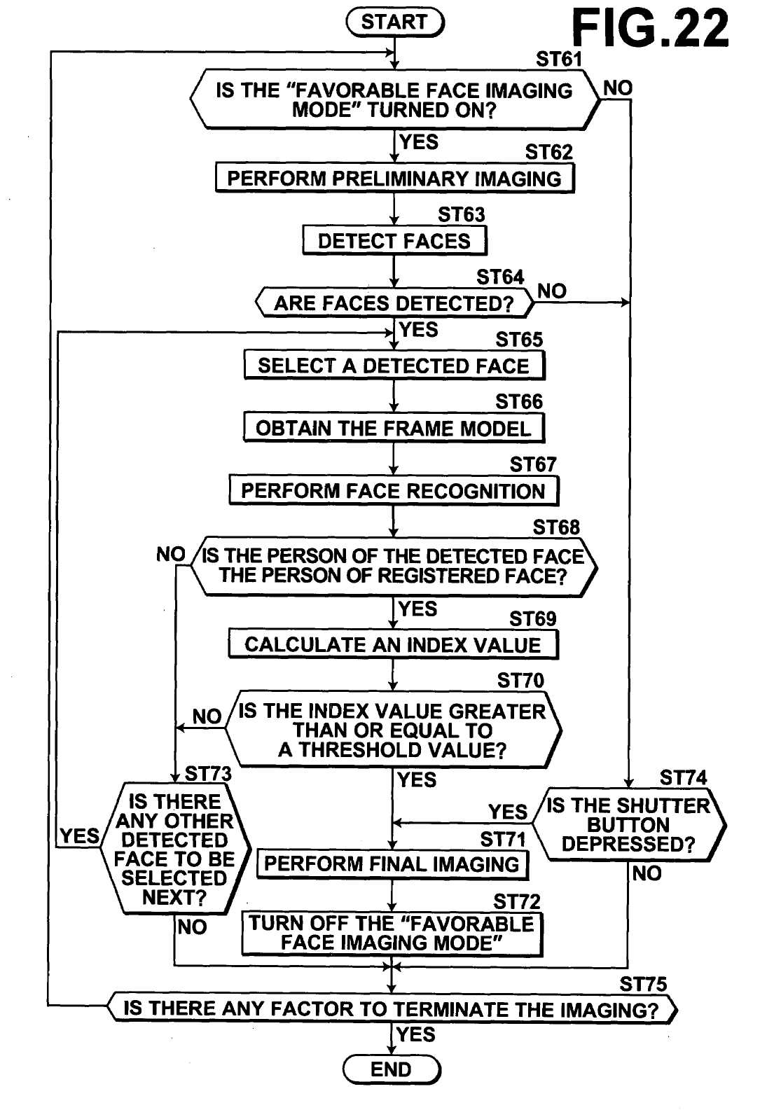

FIG. 21 is a block diagram of an imaging apparatus according to the present embodiment, illustrating the construction thereof. The imaging apparatus of the present embodiment is an imaging apparatus that controls an imaging means so that a predetermined person is imaged with a specific face expression, and includes similar functions to those included in the specific expression face image retrieval system described above.

As shown in FIG. 21, the imaging apparatus of the present embodiment includes: an imaging means 100 having an imaging device; an image registration section (image registration means) 10 that accepts registration of an image R0 that includes the face of a predetermined person with a specific expression; an image input section (image input means) 20 that accepts input of an image S0 obtained through a preliminary imaging by the imaging means 100, (hereinafter, the image S0 is also referred to as “preliminarily recorded image S0”); a face image detection section (face image detection means) 30 that detects a face image R2 that includes a face portion from the registered image R0 (hereinafter, the face image R2 is also referred to as “registered face image R2”), and detects all face images S2 that include face portions from the preliminarily recorded image S0 (hereinafter, the face image S2 is also referred to as “detected face image S2”); a frame model building section (face characteristic point extraction means) 40 that obtains a frame model Shr that includes the characteristic points that indicate the contours of face components forming the face in the registered face image R2, and a frame model Shs that includes the characteristic points that indicate the contours of face components forming the face in detected face image S2. The apparatus further includes: a memory 50 that stores data of the frame model Shr; a face recognition section (face recognition means) 60 that performs face recognition on the detected face images S2 to select an image S3 that includes the face of the same person as the predetermined person from all of the detected face images S2; an index value calculation section (index value calculation means) 70 that calculates an index value U that indicates the correlation in the positions of the characteristic points by comparing a frame model Shsa that includes the characteristic points extracted from the selected face image S3 with the frame model Shr that includes the characteristic points extracted from the registered face image R2; an expression determination section (expression determination means) 80 that determines whether the selected face image S3 includes a face with an expression similar to the specific expression described above based on the magnitude of the index value U; and an imaging control section (imaging control means) 110 that control the imaging means 100 to allow final imaging.

The image registration section 10, face image detection section 30, frame model building section 40, memory 50, face recognition section 60, index value calculation section 70, and expression determination means 80 in the present embodiment have identical functions to those of the specific expression image retrieval system described above. Therefore, they will not be elaborated upon further here.

The image input section 20 of the present embodiment basically has the identical function in the case of the specific expression face retrieval system described above, but it accepts a preliminarily recorded image S0 obtained by the imaging means 100 through preliminary imaging instead of retrieval target images. The preliminarily recorded image S0 may be an image singly recorded immediately after the shutter button is depressed halfway and the auto-focus function is operated or time series frame images obtained at predetermined time intervals as in a moving picture.

When a detected face image S2, determined by the face recognition section 60 to include the face of the same person as the predetermined person in the registered image R0, is determined by the expression determination section 80 to include a face with an expression similar to the specific expression of the face in the registered face image R2, the imaging means is allowed by the imaging control section 110 to perform final imaging. The final imaging may be performed by the user by depressing the shutter button while final imaging is granted, or automatically performed when the final imaging is granted.

FIG. 22 is a flowchart illustrating a process performed in the imaging apparatus according to the embodiment shown in FIG. 21. Although, the imaging apparatus requires an image registration process for registering an image that includes the face of a predetermined person with a specific face expression, the description thereof is omitted here, since it is identical to the image registration process in the specific expression face image retrieval system shown in FIG. 19.

First, the imaging apparatus determines whether a “favorable face imaging mode”, which is a function that provides support such that a face with a specific expression is imaged, is activated (step ST61). If the “favorable face imaging mode” is activated, a preliminary imaging is performed by the imaging means 100, and the preliminarily recorded image S0 obtained by the imaging means 100 through the preliminary imaging is accepted, and the preliminarily recorded image S0 is stored in the memory 50 by the image input section 20 (step ST62). In the mean time, if the “favorable face imaging mode” is not activated, the process proceeds to step ST74.

After the preliminary imaging is performed, the preliminarily recorded image S0 is read out from the memory 50, and face detection is performed on the image S0 by the face image detection section 30 to detect all face images S2 that include face portions (step ST63). Here, a determination is made whether a face image is detected (step ST64), and if the determination result is positive, one of the detected face images S2 is selected (step ST65), and a frame model Shs that includes the characteristic points of the face included in the selected face image S2 is obtained by the frame model building section 40 (step ST66). In the mean time, if the determination result is negative, the process proceeds to step ST74.

After the frame model Shs is obtained, the frame model Shr of the registered face image R2 is read out from the memory 50, and face recognition is performed by comparing the frame model Shs of the detected face image S2 with the frame model Shr (step ST67) to determine whether the detected face image S2 is an image S3 of the face of the same person as in the registered face image R2 by the face recognition section 60 (step ST68). If the detected face image S2 is the face image S3 of the predetermined person, the frame model Shr of the registered image R2 is compared with the frame model Shs of the detected face image S3 further in detail by the index value calculation section 70 to obtain an index value U that indicates the correlation in the positions of the characteristic points between the characteristic points of the face in the registered face image R2 and the characteristic points of the face in the detected face image S3 (step ST69). In the mean time, if the detected face image S2 is not the image S3 of the face of the predetermined person, the process proceeds to step ST73.

After the index value U is calculated, a determination is made whether the index value U is greater than or equal to a predetermined threshold value Th by the expression determination section 80 (step ST70). If the result is positive, the detected face image S3 is determined to be the face image S4 that includes a face with an expression similar to the registered specific expression. Then, a final imaging is performed by the imaging means through control of the imaging control section 110, and the obtained final recorded image is stored in the memory 50 (step ST71). After the final imaging is performed, the “favorable face imaging mode” is switched to OFF (step ST72). If imaging is further performed with the “favorable face imaging mode” switched to ON, it is necessary to manually switch the “favorable face imaging mode” to ON. The switching of the “favorable face imaging mode” to OFF after final imaging is not mandatory. In the mean time, if the determination result is negative, the process proceeds to step ST73.

In step ST73, a determination is made whether there is any other detected face image S2 to be selected next. If the determination result is positive, the process returns to step ST65 to select a new detected face image S2. If the determination result is negative, the process proceeds to step ST75.

In step ST74, a determination is made whether the shutter button is depressed. If the determination result is positive, the process proceeds to step ST71, while if the determination result is negative, the process proceeds to step ST75.

In step ST75, a determination is made whether there is any factor to terminate the imaging. If the determination result is negative, the process proceeds to step ST61 to continue the imaging, while if the determination result is positive, the imaging is terminated.

As described above, according to the imaging apparatus of the present embodiment, a final imaging is performed if a face with an expression similar to the specific expression of the face in the registered image R0 is included in a preliminarily recorded image obtained by preliminary imaging. Thus, an image that includes a face with any expression desired by the user may be obtained automatically if an image that includes a face with the desired expression is registered in advance.

Further, it is also possible to register an image that includes a face with an unfavorable expression, and the final imaging is not allowed when the preliminarily recorded image is determined to include a face with the unfavorable expression by applying the method described above.

Next, a still another embodiment of the present invention will be described.

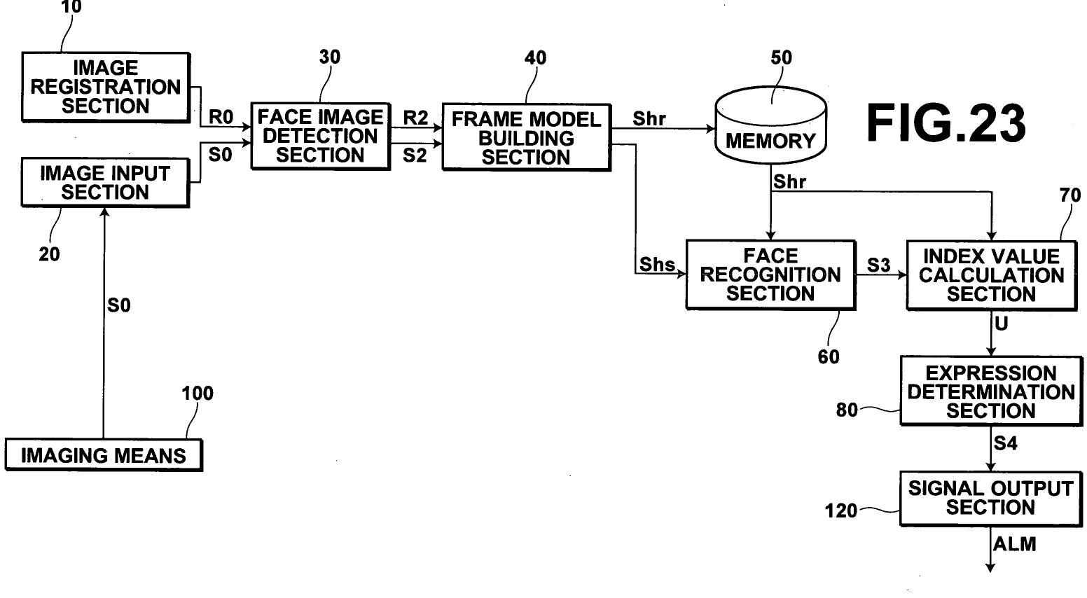

FIG. 23 is a block diagram of the imaging apparatus according to the present embodiment, illustrating the construction thereof. The imaging apparatus of the present embodiment is an imaging apparatus that outputs a signal indicating that a predetermined person is imaged with a predetermined expression, when such imaging is performed, and includes similar functions to those included in the specific expression face image retrieval system described above.

As shown in FIG. 23, the imaging apparatus of the present embodiment includes: an imaging means 100 having an imaging device; an image registration section (image registration means) 10 that accepts registration of an image R0 that includes the face of a predetermined person with a specific expression; an image input section (image input means) 20 that accepts input of an image S0 obtained by the imaging means 100, (hereinafter, the image S0 is also referred to as “recorded image S0”); a face image detection section (face image detection means) 30 that detects a face image R2 that includes a face portion from the registered image R0 (hereinafter, the face image R2 is also referred to as “registered face image R2”), and detects all face images S2 that include face portions from the recorded image S0 (hereinafter, the face image S2 is also referred to as “detected face image S2”); a frame model building section (face characteristic point extraction means) 40 that obtains a frame model Shr that includes the characteristic points that indicate the contours of face components forming the face in the registered face image R2, and a frame model Shs that includes the characteristic points that indicate the contours of face components forming the face in detected face image S2. The apparatus further includes: a memory 50 that stores data of the frame model Shr; a face recognition section (face recognition means) 60 that performs face recognition on the detected face images S2 to select an image S3 that includes the face of the same person as the predetermined person from all of the detected face images S2; an index value calculation section (index value calculation means) 70 that calculates an index value U that indicates the correlation in the positions of the characteristic points by comparing a frame model Shsa that includes the characteristic points extracted from the selected face image S3 with the frame model Shr that includes the characteristic points extracted from the registered face image R2; an expression determination section (expression determination means) 80 that determines whether the selected face image S3 includes a face with the expression similar to the specific expression based on the magnitude of the index value U; and a signal output section (notification means) that outputs a signal of sign, voice, sound, light, or the like, which indicates that a face with an expression similar to the registered specific expression is imaged in response to the determination that the face image S3 includes a face with an expression similar to the registered specific expression.

The image registration section 10, face image detection section 30, frame model building section 40, memory 50, face recognition section 60, index value calculation section 70, and expression determination means 80 in the present embodiment have identical functions to those of the specific expression image retrieval system described above. Therefore, they will not be elaborated upon further here.

The image input section 20 of the present embodiment basically has the identical function in the case of the specific expression face retrieval system described above, but it accepts a recorded image S0 obtained by the imaging of the imaging means 100 instead of retrieval target images.

When a detected face image S2, determined by the face recognition section 60 to include the face of the same person as the predetermined person in the registered image R0, is determined by the expression determination section 80 to include a face with an expression similar to the specific expression of the face in the registered face image R2, the signal output section 120 outputs a sensuous notification signal. For example, it displays a mark, a symbol, or the like, turns on a lamp, outputs a voce or a buzzer sound, provides vibrations, or the like.

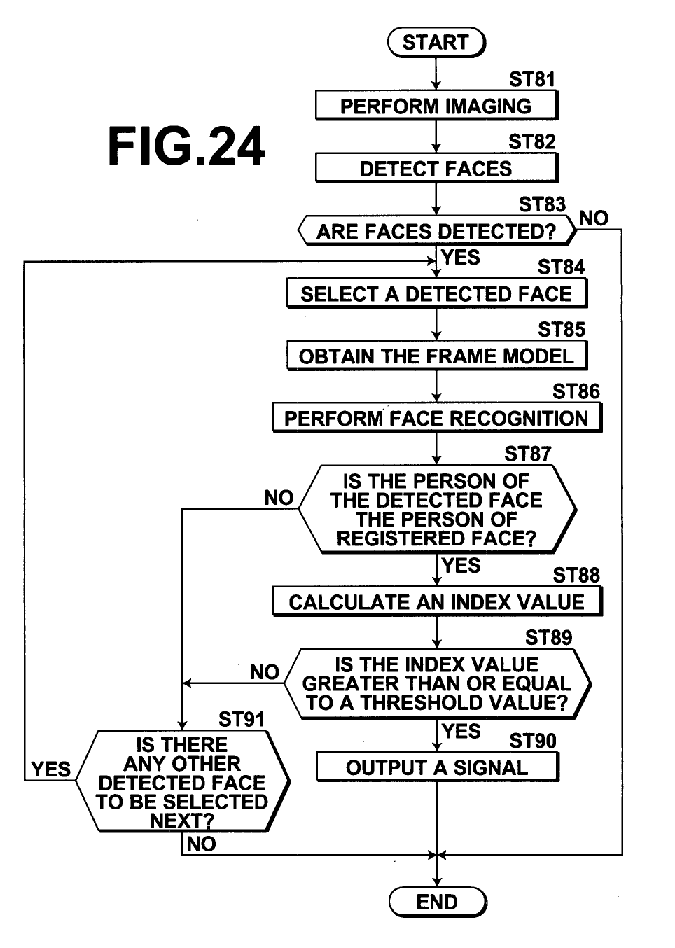

FIG. 24 is a flowchart illustrating a process performed in the imaging apparatus according to the embodiment shown in FIG. 23. Although, the imaging apparatus requires an image registration process for registering an image that includes the face of a predetermined person with a specific face expression, the description thereof is omitted here, since it is identical to the image registration process in the specific expression face image retrieval system shown in FIG. 19.

When imaging is performed by the imaging means 100 through user operation, the recorded image S0 obtained by the imaging of the imaging means 100 is accepted, and the recorded image is stored in the memory 50 by the image input section 20 (step ST81).

The recorded image S0 is read out from the memory 50, and face detection is performed on the image S0 by the face image detection section 30 to detect all face images S2 that include face portions (step ST82). Here, a determination is made whether a face image is detected (step ST83), and if the determination result is positive, one of the detected face images S2 is selected (step ST84), and a frame model Shs that includes the characteristic points of the face included in the selected face image S2 is obtained by the frame model building section 40 (step ST85). In the mean time, if the determination result is negative, the process is terminated.

After the frame model Shs is obtained, the frame model Shr of the registered face image R2 is read out from the memory 50, and face recognition is performed by comparing the frame model Shs with the frame model Shr of the detected face image S2 (step ST86) to determine whether the detected face image S2 is an image S3 of the face of the same person as in the registered face image R2 by the face recognition section 60 (step ST87). If the detected face image S2 is the face image S3 of the predetermined person, the frame model Shr of the registered image R2 is compared with the frame model Shs of the detected face image S3 further in detail by the index value calculation section 70 to obtain an index value U that indicates the correlation in the positions of the characteristic points between the characteristic points of the face in the registered face image R2 and the characteristic points of the face in the detected face image S3 (step ST88). In the mean time, if the detected face image S2 is not the image S3 of the face of the predetermined person, the process proceeds to step ST91.

After the index value U is calculated, a determination is made whether the index value U is greater than or equal to a predetermined threshold value Th by the expression determination section 80 (step ST89). If the determination result is positive, the detected face image S3 is determined to be a face image S4 that includes a face with an expression similar to the registered specific expression. Then, a signal notifying that a face with an expression similar to the registered specific expression was obtained is outputted from the signal output section 120 (step ST90), and the process is terminated.

In step ST91, a determination is made whether there is any other detected face image S2 to be selected next. If the determination result is positive, the process returns to step ST84 to select a new detected face image S2. If the determination result is negative, the process is terminated.

As described above, according to the imaging apparatus of the present embodiment, if a face with an expression similar to the specific expression of the registered image R0 is determined to be included in a recorded image obtained through imaging, a signal notifying that a face with an expression similar to the specific expression was obtained is outputted. Thus, the user may know that a face with an expression similar to the registered specific expression without confirming the image obtained through the imaging, which allows the imaging to be performed smoothly and efficiently. For example, if an image that includes a face with a favorable expression is registered, the user may know that a face with the favorable expression was obtained when such imaging was performed without confirming the image. It has a further advantage that the imaging itself may be performed freely, since the notification is implemented simply by outputting a signal, unlike the case in which the imaging means is controlled.

In the present embodiment, a notification signal is outputted when a face with an expression similar to the registered specific expression is obtained. Alternatively, the signal may be outputted when a face with an expression similar to the registered specific expression was not obtained.

So far, exemplary embodiments of the present invention have been described. But the method, apparatus and program therefor are not limited to the embodiments described above, and it will be apparent that various modifications, additions, and subtractions may be made without departing from the spirit and scope of the present invention.

What is claimed is:

1. A specific expression face detection method, comprising the steps of:
accepting registration of an image that includes the face of a predetermined person with a specific face expression;
extracting characteristic points that indicate the contours of face components forming the face in the registered face image;
accepting input of a detection target image;
detecting a face image that includes a face from the detection target image;
extracting characteristic points that indicate the contours of face components forming the face in the detected face image;
calculating an index value that indicates the correlation in the positions of the characteristic points by comparing the characteristic points extracted from the face in the detected face image with the characteristic points extracted from the face in the registered image; and
determining whether the detected face image includes a face with an expression similar to the specific expression based on the magnitude of the index value.

2. The specific expression face detection method according to claim 1, wherein:
the method further comprises the step of selecting a face image that includes the face of the same person as the predetermined person from all of the detected face images by performing face recognition thereon;
the step of calculating an index value calculates the index value by comparing the characteristic points extracted from the face in the selected face image with the characteristic points extracted from the face in the registered image; and
the determining step determines whether the selected face image includes a face with an expression similar to the specific expression.

3. The specific expression face detection method according to claim 1, wherein:
the step of accepting input of a detection target image accepts input of a plurality of different images;
the step of detecting a face image, the step of extracting characteristic points from the detected face image, the step of calculating an index value, and the determining step are performed on each of the plurality of different images; and
the method further comprises the step of selecting an image that includes the face image determined to include a face with an expression similar to the specific expression and outputting information that identifies the selected image.

4. The specific expression face detection method according to claim 1, wherein:
the detection target image is an image obtained by an imaging means through imaging; and
the method further comprises the step of outputting at least one of a sign, a voice, a sound, and light according to the determination result to notify the determination result.

5. An imaging control method, comprising the steps of:
accepting registration of an image that includes the face of a predetermined person with a specific face expression;
extracting characteristic points that indicate the contours of face components forming the face in the registered face image;
accepting input of a preliminarily recorded image obtained by an imaging means through preliminary imaging;
detecting a face image that includes a face from the preliminarily recorded image;
extracting characteristic points that indicate the contours of face components forming the face in the detected face image;
calculating an index value that indicates the correlation in the positions of the characteristic points by comparing the characteristic points extracted from the face in the detected face image with the characteristic points extracted from the face in the registered image;
determining whether the detected face image includes a face with an expression similar to the specific expression based on the magnitude of the index value; and
controlling the imaging means to allow final imaging according to the determination result.

6. The imaging control method according to claim 5, wherein:
the method further comprises the step of selecting a face image that includes the face of the same person as the predetermined person from all of the detected face images by performing face recognition thereon;
the step of calculating an index value calculates the index value by comparing the characteristic points extracted from the face in the selected face image with the characteristic points extracted from the face in the registered image; and
the determining step determines whether the selected face image includes a face with an expression similar to the specific expression.

7. The imaging control method according to claim 5, wherein the step of controlling the imaging means to allow final imaging performs the control of allowing final imaging according to the determination result that the detected face image includes a face with an expression similar to the specific expression.

8. The imaging control method according to claim 5, wherein the step of controlling the imaging means to allow final imaging performs the control of allowing final imaging according to the determination result that the detected face image does not include a face with an expression similar to the specific expression.

9. A specific expression face detection apparatus, comprising:
an image registration means for accepting registration of an image that includes the face of a predetermined person with a specific face expression;
a first face characteristic point extraction means for extracting characteristic points that indicate the contours of face components forming the face in the registered face image;
an image input means for accepting input of a detection target image;
a face image detection means for detecting a face image that includes a face from the detection target image;
a second face characteristic point extraction means for extracting characteristic points that indicate the contours of face components forming the face in the detected face image;
an index value calculation means for calculating an index value that indicates the correlation in the positions of the characteristic points by comparing the characteristic points extracted from the face in the detected face image with the characteristic points extracted from the face in the registered image; and
an expression determination means for determining whether the detected face image includes a face with an expression similar to the specific expression based on the magnitude of the index value.

10. The specific expression face detection apparatus according to claim 9, wherein:
the apparatus further comprises a face recognition means for performing face recognition on the detected face images to select a face image that includes the face of the same person as the predetermined person from all of the detected face images;
the index value calculation means calculates the index value by comparing the characteristic points extracted from the face in the selected face image with the characteristic points extracted from the face in the registered image; and
the expression determination means determines whether the selected face image includes a face with an expression similar to the specific expression.

11. The specific expression face detection apparatus according to claim 9, wherein:
the image input means accepts input of a plurality of different images;
the detection of a face image by the face image detection means, the extraction of characteristic points by the second face characteristic point extraction means, the calculation of an index value by the index value calculation means, and the determination by the expression determination means are performed on each of the plurality of different images; and
the apparatus further comprises an output means for selecting an image that includes the face image determined to include a face with an expression similar to the specific expression, and outputting information that identifies the selected image.

12. The specific expression face detection apparatus according to claim 9, wherein:
the detection target image is an image obtained by an imaging means through imaging; and
the apparatus further comprises a notification means for outputting at least one of a sign, a voice, a sound, and light according to the determination result to notify the determination result.

13. An imaging control apparatus, comprising:
an image registration means for accepting registration of an image that includes the face of a predetermined person with a specific face expression;
a first face characteristic point extraction means for extracting characteristic points that indicate the contours of face components forming the face in the registered face image;
an image input means for accepting input of a preliminarily recorded image obtained by an imaging means through preliminary imaging;
a face image detection means for detecting a face image that includes a face from the preliminarily recorded image;
a second face characteristic point extraction means for extracting characteristic points that indicate the contours of face components forming the face in the detected face image;
an index value calculation means for calculating an index value that indicates the correlation in the positions of the characteristic points by comparing the characteristic points extracted from the face in the detected face image with the characteristic points extracted from the face in the registered image;
an expression determination means for determining whether the detected face image includes a face with an expression similar to the specific expression based on the magnitude of the index value; and
an imaging control means for controlling the imaging means to allow final imaging according to the determination result.

14. The imaging control apparatus according to claim 13, wherein:
the apparatus further comprises a face recognition means for performing face recognition on the detected face images to select a face image that includes the face of the same person as the predetermined person from all of the detected face images;
the index value calculation means calculates the index value by comparing the characteristic points extracted from the face in the selected face image with the characteristic points extracted from the face in the registered image; and
the expression determination means determines whether the selected face image includes a face with an expression similar to the specific expression.

15. The imaging control apparatus according to claim 13, wherein the imaging control means performs the control of allowing final imaging according to the determination result that the detected face image includes a face with an expression similar to the specific expression.

16. The imaging control apparatus according to claim 13, wherein the imaging control means performs the control of allowing final imaging according to the determination result that the detected face image does not include a face with an expression similar to the specific expression.

17. A program for causing a computer to function as a specific expression face detection apparatus by causing the computer to function as:
an image registration means for accepting registration of an image that includes the face of a predetermined person with a specific face expression;
a first face characteristic point extraction means for extracting characteristic points that indicate the contours of face components forming the face in the registered face image;
an image input means for accepting input of a detection target image;
a face image detection means for detecting a face image that includes a face from the detection target image;
a second face characteristic point extraction means for extracting characteristic points that indicate the contours of face components forming the face in the detected face image;
an index value calculation means for calculating an index value that indicates the correlation in the positions of the characteristic points by comparing the characteristic points extracted from the face in the detected face image with the characteristic points extracted from the face in the registered image; and
an expression determination means for determining whether the detected face image includes a face with an expression similar to the specific expression based on the magnitude of the index value.

18. The program according to claim 17, wherein:
the program causes the computer to further function as a face recognition means for performing face recognition on the detected face images to select a face image that includes the face of the same person as the predetermined person from all of the detected face images;
the index value calculation means calculates the index value by comparing the characteristic points extracted from the face in the selected face image with the characteristic points extracted from the face in the registered image; and
the expression determination means determines whether the selected face image includes a face with an expression similar to the specific expression.

19. The program according to claim 17, wherein:
the image input means accepts input of a plurality of different images;
the detection of a face image by the face image detection means, the extraction of characteristic points by the second face characteristic point extraction means, the calculation of an index value by the index value calculation means, and the determination by the expression determination means are performed on each of the plurality of different images; and
the program causes the computer to further function as an output means for selecting an image that includes the face image determined to include a face with an expression similar to the specific expression, and outputting information that identifies the selected image.

20. The program according to claim 17, wherein:
the detection target image is an image obtained by an imaging means through imaging; and
the program causes the computer to further function as a notification means for outputting at least one of a sign, a voice, a sound, and light according to the determination result to notify the determination result.

21. A program for causing a computer to function as an imaging control apparatus by causing the computer to function as:
an image registration means for accepting registration of an image that includes the face of a predetermined person with a specific face expression;
a first face characteristic point extraction means for extracting characteristic points that indicate the contours of face components forming the face in the registered face image;
an image input means for accepting input of a preliminarily recorded image obtained by an imaging means through preliminary imaging;
a face image detection means for detecting a face image that includes a face from the preliminarily recorded image;
a second face characteristic point extraction means for extracting characteristic points that indicate the contours of face components forming the face in the detected face image;
an index value calculation means for calculating an index value that indicates the correlation in the positions of the characteristic points by comparing the characteristic points extracted from the face in the detected face image with the characteristic points extracted from the face in the registered image;
an expression determination means for determining whether the detected face image includes a face with an expression similar to the specific expression based on the magnitude of the index value; and
an imaging control means for controlling the imaging means to allow final imaging according to the determination result.

22. The program according to claim 21, wherein:
the program causes the computer to further function as a face recognition means for performing face recognition on the detected face images to select a face image that includes the face of the same person as the predetermined person from all of the detected face images;
the index value calculation means calculates the index value by comparing the characteristic points extracted from the face in the selected face image with the characteristic points extracted from the face in the registered image; and
the expression determination means determines whether the selected face image includes a face with an expression similar to the specific expression.

23. The program according to claim 21, wherein the imaging control means performs the control of allowing final imaging according to the determination result that the detected face image includes a face with an expression similar to the specific expression.

24. The program according to claim 21, wherein the imaging control means performs the control of allowing final imaging according to the determination result that the detected face image does not include a face with an expression similar to the specific expression.
